(19) United States
(12) Patent Application Publication
(10) Pub. No.: US 2026/0355927 A1
(43) Pub. Date: Nov. 12, 2026

(54) Modular Plate Assemblies

(71) Applicant: FIREBALL TOOL WORKS LLC, Spokane, WA (US)

(72) Inventors: Jason A. Marburger, Spokane, WA (US); Elliott Ian Wong, Alhambra, CA (US)

(73) Assignee: FIREBALL TOOL WORKS LLC, Spokane, WA (US)

(21) Appl. No.: 19/203,693

(22) Filed: May 9, 2025

(51) Int. Cl. B25H 1/02

(52) U.S. Cl. CPC B25H 1/02

(57) ABSTRACT

Modular plate assemblies are described. In an example, a modular plate assembly includes a plate body, a frame assembly, and a base assembly that are connectable to one another in various configurations. In various embodiments, the modular plate assembly includes an alignment system to support secure attachment of the frame assembly and plate body to the base assembly at particular orientations, such as via complementary alignment grooves of the frame assembly and alignment protrusions on the base assembly. Additionally or alternatively, the modular plate assembly includes a leveling system to enable precise leveling and positioning of the plate body. The leveling system includes a configuration of leveling components that can adjust a position of the plate body relative to the frame assembly. Thus, the assemblies and components described herein provide a versatile and adjustable system for creating surfaces for a variety of working scenarios.

### BACKGROUND

Welding tables are commonly used in metalworking to secure and position workpieces for various fabrication tasks. Traditional welding tables often feature a fixed top surface with a grid of holes for attaching clamps, fixtures, and other accessories. However, these conventional designs present limitations in terms of adaptability and precision. The fixed nature of standard welding tables may restrict an ability to accommodate workpieces of varying sizes or complex shapes. Additionally, achieving and maintaining a flat work surface across the table can be challenging, for instance over time as wear and stresses cause a surface of the table to distort. These constraints impact efficiency and quality of welding and fabrication processes and restrict flexibility in workspace setup.

### SUMMARY

Modular plate assemblies are described that support versatile configurations for various work tasks. An example modular plate assembly includes a plate body, a frame assembly, and a base assembly. The plate body includes apertures that extend from a top surface of the plate body to a bottom surface of the plate body, such as to attach fixtures, work members, and/or components of the frame assembly. In various embodiments, the frame assembly includes alignment members with grooves that correspond to alignment protrusions on the base assembly, which enable secure attachment of the frame assembly and plate body to the base assembly at particular orientations and positions. This modular design allows for quick assembly and disassembly of customizable workstation setups.

In some examples, the modular plate assembly further includes a leveling system to enable precise leveling and positioning of the work surface. The leveling system, for instance, includes a configuration of leveling components that are operable to adjust a position of individual portions the plate body relative to the frame assembly. Thus, the assemblies and components described herein further support precision and adaptability which is not achievable with conventional welding tables.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIGS. 1a and 1b depict views of an example modular plate assembly in accordance with one or more implementations.

FIG. 2 shows a top view of a plate body of a modular plate assembly in accordance with one or more implementations.

FIG. 3 depicts an example of the frame assembly in a first view and a second view in accordance with one or more implementations.

FIG. 4 depicts a view of the plate body disengaged from the frame assembly in accordance with one or more implementations in accordance with one or more implementations.

FIG. 5 depicts a bottom view of the plate body with the frame assembly attached in accordance with one or more implementations.

FIG. 6 depicts an example of attaching a plate body, a frame assembly, and a base assembly to one another in accordance with one or more implementations.

FIG. 7 depicts an additional view of attachment of the plate body and frame assembly to the base assembly in accordance with one or more implementations.

FIG. 8 depicts a view of the plate body, the frame assembly, and the base assembly attached to one another in a particular configuration in accordance with one or more implementations.

FIG. 9 depicts an example of attachment of an additional plate body to a base assembly in accordance with one or more implementations.

FIG. 10 depicts an additional example of attachment of additional plate bodies to a base assembly in accordance with one or more implementations.

FIG. 11 depicts an example of the plate body, the second plate body, and the third plate body attached to form a larger work surface in accordance with one or more implementations.

FIGS. 12a and 12b depict examples of configurations of alignment system components in accordance with one or more implementations.

FIG. 13 depicts an example of a modular plate assembly with multiple plate bodies attached to a base assembly in accordance with one or more implementations.

FIG. 14 depicts an additional example of a modular plate assembly with multiple plate bodies attached to a base assembly in accordance with one or more implementations.

FIG. 15 depicts an example of an assembled modular plate assembly with multiple plate bodies attached in accordance with one or more implementations.

FIG. 16 depicts an example of a standalone configuration for a plate body in accordance with one or more implementations in a first stage and a second stage.

FIG. 17 depicts an example of a modular plate assembly that includes one or more rotational components in accordance with one or more implementations.

FIG. 18 depicts an example of a rotational component in accordance with one or more implementations.

FIGS. 19a and 19b depict examples of rotation of the modular plate assembly about the rotational component in accordance with one or implementations.

FIG. 20 depicts an example of a leveling system of a modular plate assembly in accordance with one or more implementations.

FIG. 21 depicts an example of a leveling component of a modular plate assembly in accordance with one or more implementations.

FIG. 22 depicts a top view of apertures of the plate body in accordance with one or more implementations.

FIG. 23 depicts an example of components of a leveling system to attach a plate body to a frame assembly in accordance with one or more implementations.

FIG. 24 depicts an example of a portion of the plate body attached to the frame assembly via a leveling component in accordance with one or more implementations.

FIG. 25 depicts an example showing adjustment of the leveling screw in accordance with one or more implementations.

FIGS. 26a and 26b depict examples showing adjustment of the fasteners of a leveling component in accordance with one or more implementations.

FIG. 27 depicts an example showing a leveling system that includes multiple leveling components in accordance with one or more implementations.

FIG. 28 depicts an additional example showing a leveling system that includes multiple leveling components in accordance with one or more implementations.

FIG. 29 depicts an additional example showing a leveling system that includes multiple leveling components in accordance with one or more implementations.

FIG. 30 depicts an example in which a modular plate assembly includes a leveling system and an alignment system in accordance with one or more implementations.

### DETAILED DESCRIPTION

### Overview

Modular plate assemblies are described that support versatile welding and fabrication configurations for various work surfaces. In some implementations, a modular plate assembly includes a “quick release” alignment system that enables rapid attachment and detachment of the plate body from the base assembly while maintaining precise positioning, allowing users to easily transport, store, or reconfigure their work surface. The modular plate assembly may also include a leveling system with strategically positioned leveling components that allow for fine-tuned adjustments to the work surface, such as to adjust imprecisions and/or create intentional angles for various work requirements.

In an example, a modular plate assembly includes a plate body, a frame assembly, and a base assembly that can be attached and detached from one another in various configurations. The plate body includes apertures that extend from a top surface of the plate body to a bottom surface of the plate body. The apertures enable attachment of fixtures, work members, and/or various components of the frame assembly. For instance, the frame assembly includes one or more frame members and/or rails that are attached to the bottom surface of the plate body via the apertures, such as with fasteners inserted through corresponding apertures in both the frame members and the plate body.

In an example, the frame assembly includes an alignment system that includes alignment members configured with one or more alignment grooves. The alignment grooves, for instance, include a recessed region having a particular shape that corresponds to a shape of one or more alignment protrusions included on the base assembly. In this way, the frame assembly and plate body are attachable to the base assembly at particular orientations defined by positions of the alignment grooves and/or alignment protrusions.

For instance, the base assembly can include various sets of alignment protrusions that support variable positioning of the frame assembly and plate body. The alignment system can further include one or more “quick-release” components, e.g., quick-release pins, to enable rapid attachment and detachment of the frame assembly from the base assembly. Accordingly, the alignment system enables efficient assembly and disassembly to support customizable workstation setups.

By way of example, a metalworker is engaged in a project that involves fabrication of various pieces of varying sizes. In this scenario, conventional fixed welding tables are impractical due to an inability to adapt to different workpiece dimensions and difficulty of transporting heavy, rigid work surfaces to different locations. To overcome these limitations, the alignment system supports precise and rapid assembly and disassembly of precisely aligned modular plate components to create custom-sized work surfaces that can be configured for projects and easily transported as separate, manageable pieces while maintaining a desired alignment when reassembled.

In additional or alternative examples, the modular plate assembly includes a leveling system to enable precise leveling and positioning of the work surface. The leveling system, for instance, includes a configuration of various leveling components that are operable to adjust a position and/or orientation of the plate body relative to the frame assembly. For instance, each leveling component provides fine-tuned adjustment of various dimensions of a region of the plate body.

In an example, a leveling component includes a bracket, one or more attachment pins, and a leveling screw. The bracket is dimensioned to partially surround a member of the frame assembly, while the attachment pins secure the member to the bottom surface of the plate body. In this example, the attachment pins can be adjusted to “pull” the plate body downward towards the frame assembly. This adjustment allows for fine-tuned control of a vertical position of the plate body relative to the frame member.

Further, the leveling screw is actuatable to apply a force in an additional direction, such as to “push” the plate body upward away from the frame assembly, e.g., to raise a portion of the plate body. Accordingly, users can manipulate the leveling components of a modular clamp assembly to achieve precise control over a position and orientation of the plate body. Thus, the leveling system supports fine-tuned leveling adjustment and creation of desired angles or slopes in the work surface, such as for particular fabrication tasks.

In this way, the modular plate assemblies described herein provide a variety of advantages not attainable using conventional “fixed” welding tables. For instance, the alignment system ensures precise positioning of various components, while the leveling system supports precise adjustment to ensure a level surface. This flexibility supports adaptability of workspaces for projects of varying sizes and complexities without utilizing multiple specialized tables with varying dimensions.

Accordingly, the described modular plate assemblies provide for a multitude of configurations and adjustments not provided by conventional tools for securing and/or supporting workpieces. In the following discussion, example modular plate assemblies are described that may employ the techniques described herein. Example scenarios are also described in which the example modular plate assemblies are utilized. The example modular plate assemblies are not limited to performance of the example scenarios.

### Modular Plate Assemblies and Components

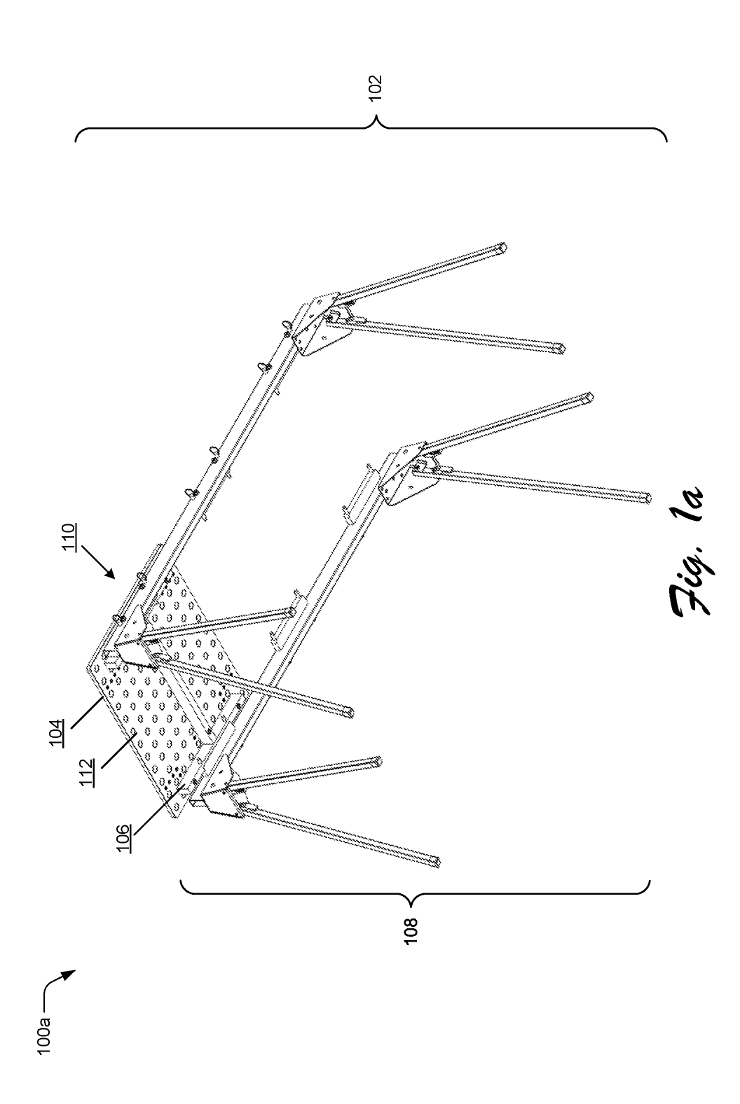

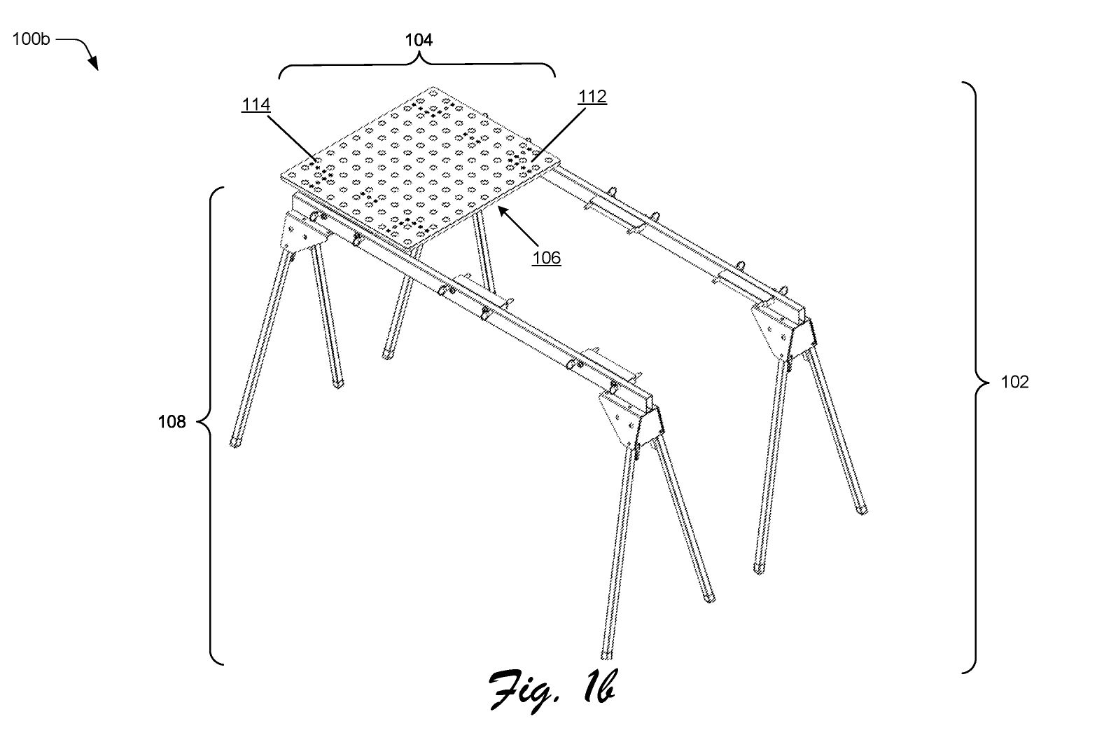

FIGS. 1–30 depict various attributes of example modular plate assemblies that are operable to employ techniques described herein. FIGS. 1a and 1b depicts a view 100a and 100b of an example modular plate assembly 102 in accordance with one or more implementations described herein. In the illustrated example, the modular plate assembly 102 includes a plate body 104, a frame assembly 106, and a base assembly 108. The plate body 104 may include a top surface 110, a bottom surface 112, and apertures 114 that extend through the plate body 104 from the top surface 110 to the bottom surface 112.

The apertures 114, for instance, enable attachment of various fixtures, clamps, work members, or other accessories to the top surface 110 of the plate body 104, such as to support variable security and positioning of workpieces for different fabrication tasks. Further, the apertures 114 enable attachment of the frame assembly 106. For instance, the frame assembly 106 may be attachable to the bottom surface 112 of the plate body 104 via one or more of the apertures 114, such as by using fasteners inserted through corresponding apertures in members or rails of the frame assembly 106. In some examples, this attachment mechanism may allow for modular configuration of the plate body 104 relative to the frame assembly 106, such as the leveling system as described in more detail below.

The base assembly 108 may be configured to support the plate body 104 and the frame assembly 106, such as to provide stability to the overall modular plate assembly 102 while maintaining flexibility in configuration. The base assembly 108 may take various forms to suit different applications and environments. For instance, the base assembly 108 may include one or more of a stationary table frame, a mobile cart with wheels, a foldable stand for portability, a wall-mounted bracket system, and so forth. In some implementations, the base assembly 108 may incorporate height adjustment mechanisms or rotational components to further enhance versatility of the modular plate assembly 102.

As further described in the following examples, the plate body 104, frame assembly 106, and base assembly 108 are combinable in various ways and configurations to create a versatile and modular system that can be adapted for different uses while maintaining structural integrity and precision in alignment.

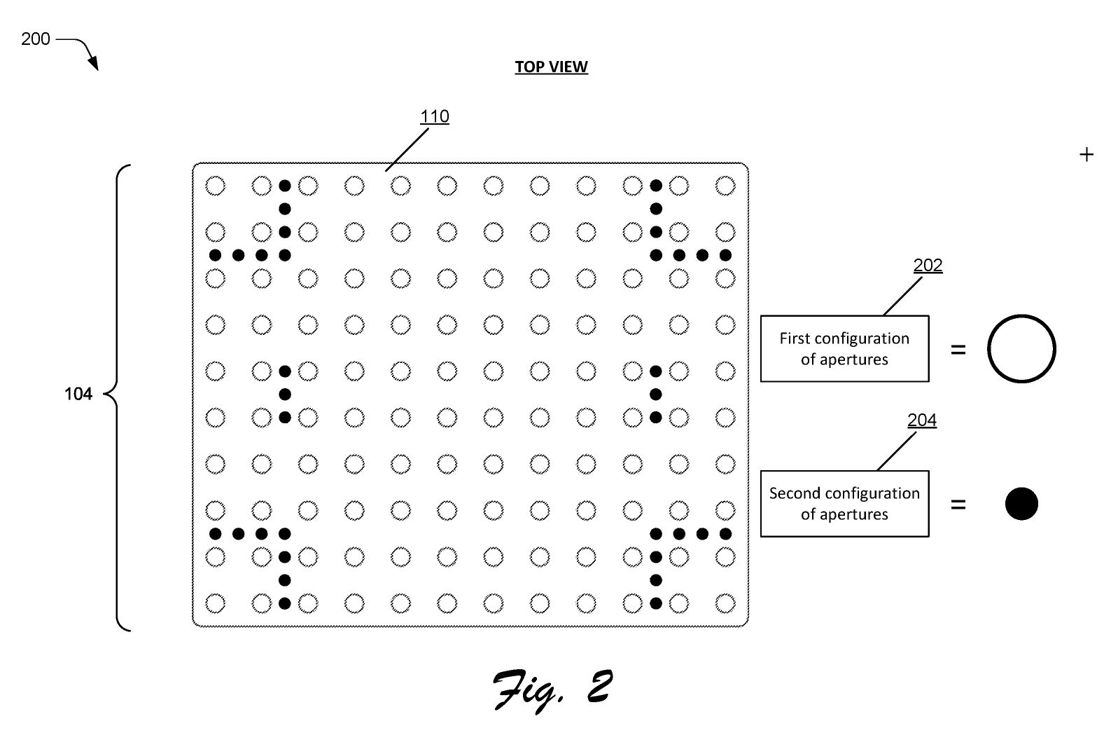

FIG. 2 shows a top view 200 of a plate body 104 of a modular plate assembly 102 in accordance with one or more implementations. For instance, the top view 200 depicts a top surface 110 of the plate body 104 with multiple apertures extending through the plate body 104, e.g., to the bottom surface 112. In this example, the plate body 104 includes a first aperture configuration 202 and a second aperture configuration 204. The first aperture configuration 202, for instance, includes apertures 114 having a first diameter arranged in a grid pattern across the top surface 110. In some cases, the first aperture configuration 202 may be used for attaching clamps, fixtures, or other accessories to the plate body 104.

While a variety of configurations are considered, in one or more implementations the apertures 114 of the first aperture configuration 202 are spaced at regular intervals, e.g., 2 inches apart in a square grid pattern. A variety of diameters for the apertures 114 of the first aperture configuration 202, such as within a range of 5/8 inch to 1 1/8 inch. This is by way of example and not limitation, and diameters larger and/or smaller than the described range are considered. In at least one example, the apertures 114 of the first aperture configuration 202 have a 3/4-inch diameter.

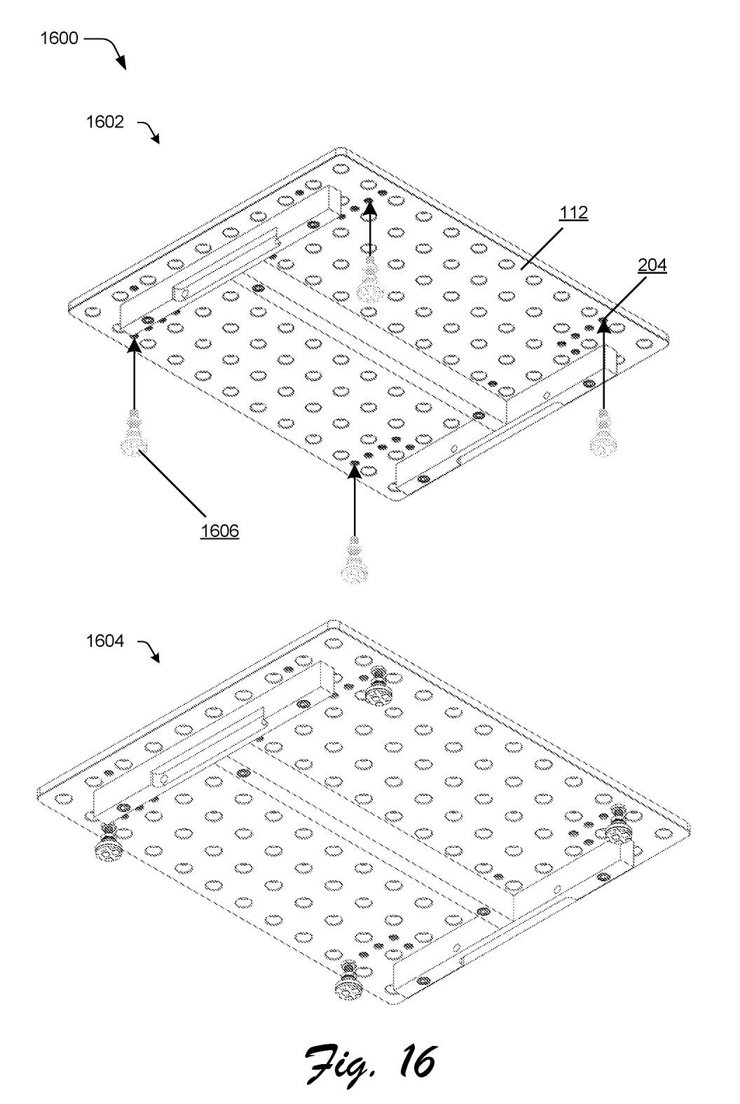

A second aperture configuration 204 includes apertures having a second diameter that may differ from the first diameter. The second aperture configuration 204 is usable to attach various components to the plate body 104, such as one or more members and/or rails of the frame assembly 106, various components of a leveling system, and/or one or more feet such as described below with respect to FIG. 16. In one or more examples, the apertures 114 of the second aperture configuration 204 are positioned along a perimeter of the plate body 104 to facilitate secure attachment to the frame assembly 106, and/or are positioned at locations to coincide with support members of the frame assembly 106.

In the illustrated example, the apertures 114 of the second aperture configuration 204 include several “groups” of apertures 114. For instance, the second aperture configuration 204 includes several “L-shaped” configurations of apertures at corners of the plate body 104, as well as two groups of three apertures 114 disposed at either end of the plate body 104 adjacent to the periphery. The apertures 114 of the second aperture configuration 204 are depicted as having a smaller diameter than the apertures 114 of the first aperture configuration 202, such as to not “interfere” with one another. In some examples, the apertures 114 of the second aperture configuration 204 have a diameter within a range of 6 mm to 14 mm, e.g., approximately 1/4 inch to 9/16 inch. This is by way of example and not limitation, and diameters larger and/or smaller than the described range are considered. In at least one example, the apertures 114 of the second aperture configuration 204 have a diameter of 1/2 inch.

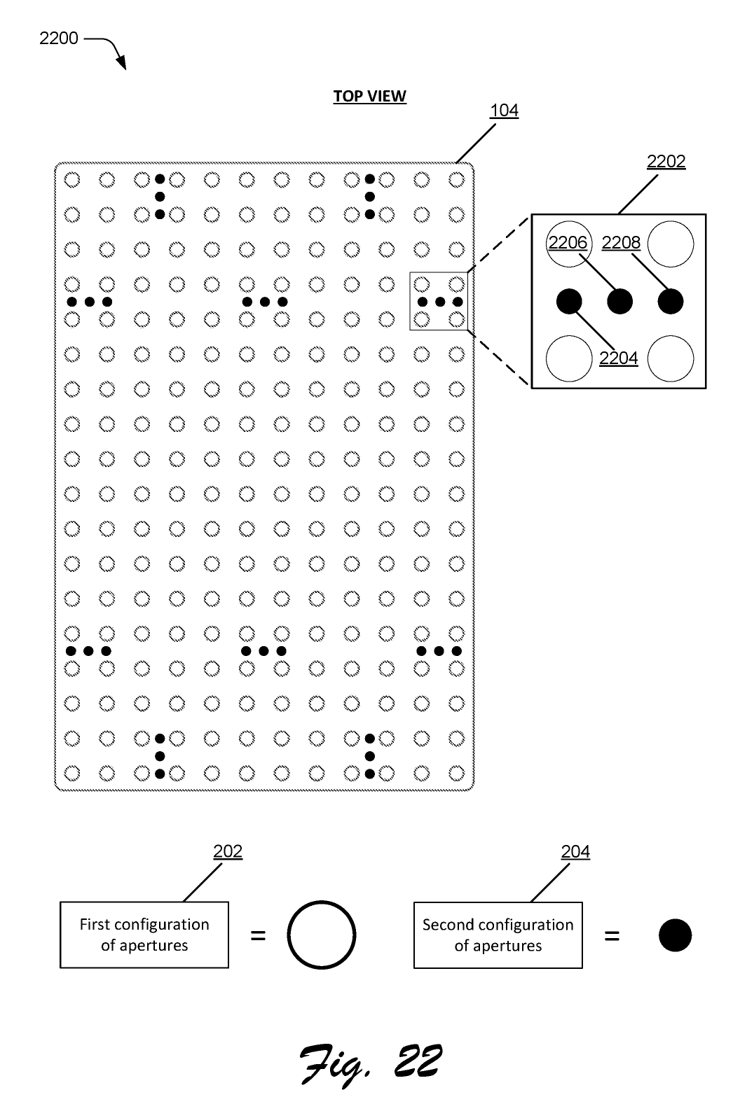

While not depicted in FIG. 2, the apertures of the second aperture configuration 204 may also be arranged in various patterns across the plate body 104, such as in clusters or along diagonal lines. In some implementations, the second aperture configuration 204 may include apertures 114 of multiple diameters and/or non-circular shapes to accommodate different types of fasteners or attachment mechanisms. Further features of the first aperture configuration 202 and second aperture configuration 204 are discussed in more detail below, such as with respect to FIG. 22.

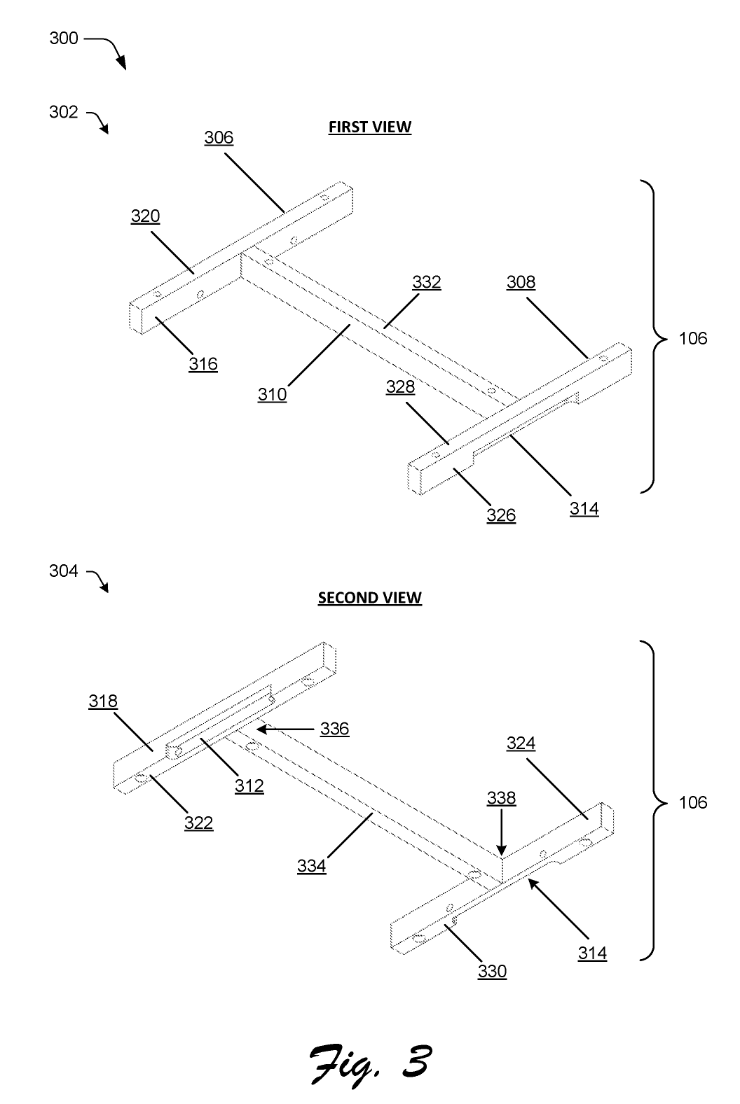

FIG. 3 depicts an example 300 of the frame assembly 106 in a first view 302 and a second view 304 in accordance with one or more implementations. The frame assembly 106, for instance, includes various frame members and/or rails that are attachable to the bottom surface 112 of the plate body 104. In the illustrated example 300, the frame assembly 106 includes a first alignment member 306, a second alignment member 308, and a central support member 310. The first alignment member 306 includes a first alignment groove 312 and the second alignment member 308 includes a second alignment groove 314.

As illustrated, the first alignment member 306 includes an inner surface 316, an outer surface 318, a top surface 320, and a bottom surface 322. Similarly, the second alignment member 308 includes an inner surface 324, an outer surface 326, a top surface 328, and a bottom surface 330. The central support member 310 includes a top surface 332, a bottom surface 334, a first end 336, and a second end 338.

The inner surface 316 of the first alignment member 306 is attached to the first end 336 of the central support member 310, such that the central support member 310 is substantially perpendicular to the first alignment member 306. In this example, the first end 336 is attached to a midpoint of the inner surface 316. The second end 338 of the central support member 310 is further attached to a midpoint of the inner surface 324 of the second alignment member 308, such that the central support member 310 is substantially perpendicular to the second alignment member 308. Accordingly, the first alignment member 306 and second alignment member 308 are substantially parallel to one another.

The central support member 310, for instance, provides structural support and maintains the relative positions of the first and second alignment members. In one or more examples, the central support member 310 further provides a surface to attach various components of the leveling system as further discussed below. The illustrated configuration of the frame members is by example and not limitation, and various configurations and numbers of frame members/rails are considered.

The outer surface 318 and bottom surface 322 of the first alignment member 306 are depicted to include the first alignment groove 312. For instance, the first alignment groove 312 is disposed on an edge of the first alignment member 306 between the outer surface 318 and the bottom surface 322. Similarly, the outer surface 326 and bottom surface 330 of the second alignment member 308 include the second alignment groove 314, e.g., on an edge between the outer surface 326 and the bottom surface 330.

In this example 300, the first alignment groove 312 and the second alignment groove 314 are depicted to include a recessed region with a rounded profile. The first alignment groove 312 and second alignment groove 314 may contribute to the modularity of the modular plate assembly 102, such as enabling precise positioning and attachment of the frame assembly 106 to other components. For instance, the first alignment groove 312 and second alignment groove 314 support attachment to the base assembly 108 as part of an alignment system of the modular plate assembly 102, as further discussed in more detail below.

The top surface 320 of the first alignment member 306, the top surface 332 of the central support member 310, and the top surface 328 of the second alignment member 308 are further depicted to include various apertures. These apertures support attachment of the frame assembly 106 to the plate body 104, such as depicted in the following example.

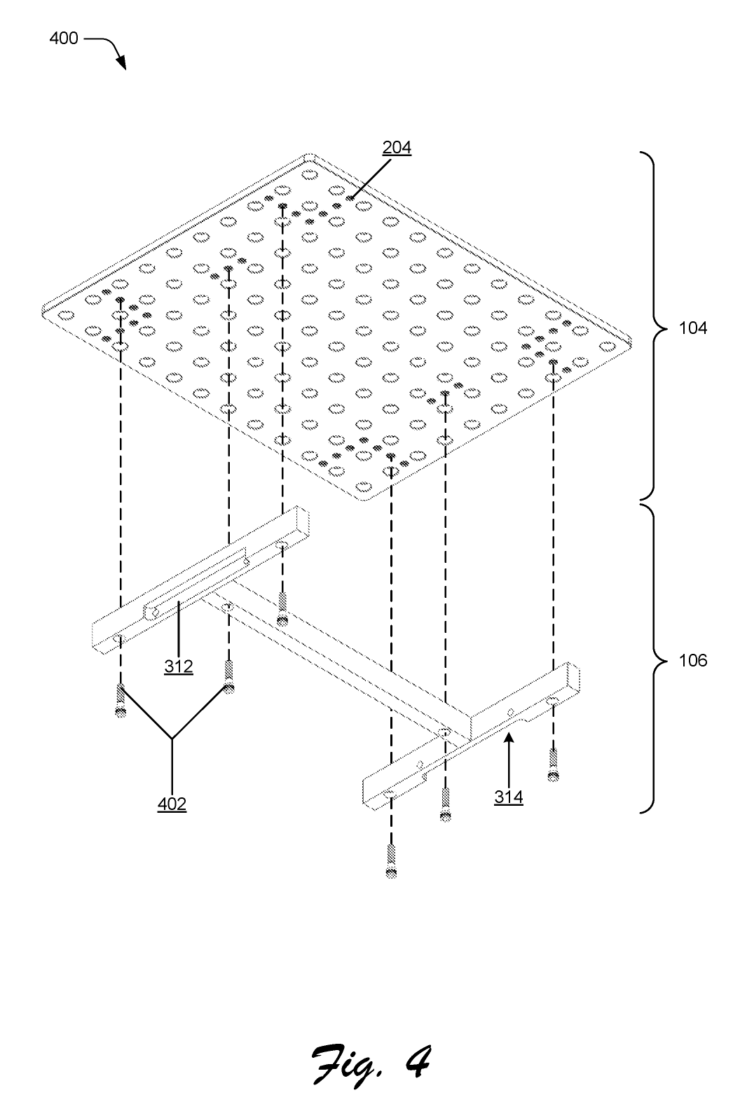

FIG. 4 depicts a view 400 of the plate body 104 disengaged from the frame assembly 106 in accordance with one or more implementations. The view 400 depicts how the frame assembly 106 is attachable to the plate body 104. For example, the frame assembly 106 may include various apertures to facilitate attachment to the plate body 104.

In this example, fasteners 402 are dimensioned to coincide with apertures of the frame assembly 106 and further with corresponding apertures 114 of the plate body 104. As illustrated, the fasteners 402 are insertable into apertures 114 of the second aperture configuration 204. Thus, the second aperture configuration 204 determines a position of the frame assembly 106 relative to the plate body 104.

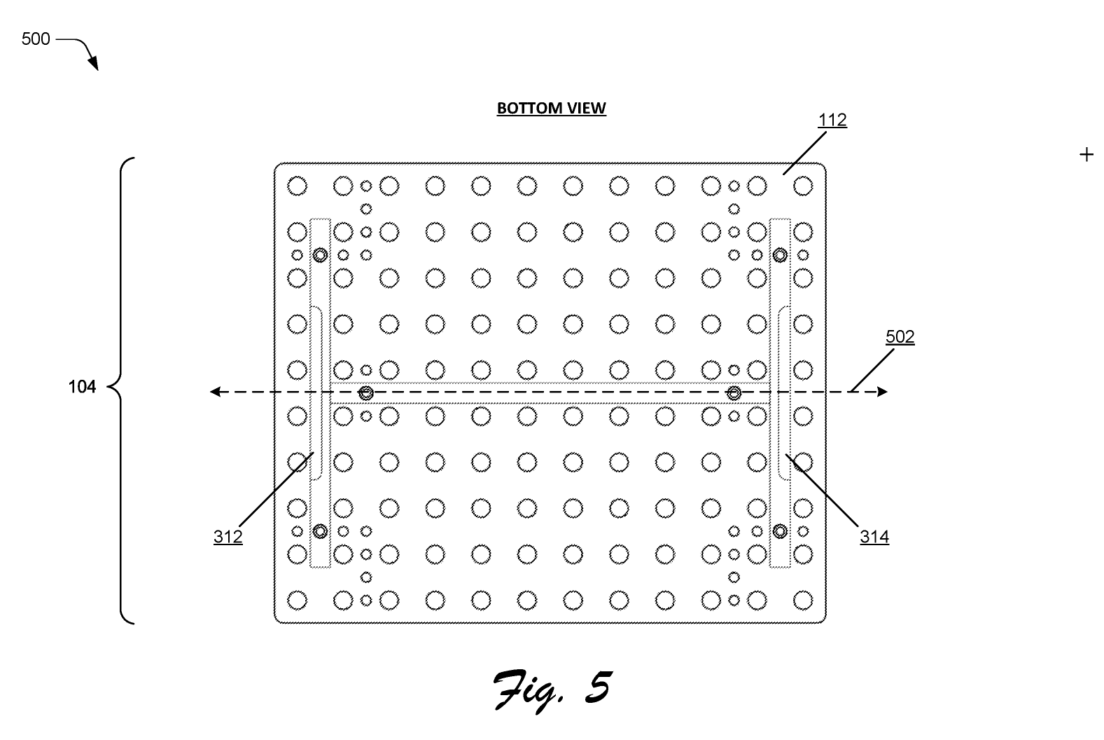

FIG. 5 depicts a bottom view 500 of the plate body 104 with the frame assembly 106 attached in accordance with one or more implementations. In this example, the frame assembly 106 has been affixed to the plate body 104, such as in accordance with the techniques described above with respect to FIG. 4.

The view 500 further illustrates a shape and positioning of the first alignment groove 312 and the second alignment groove 314 of the frame assembly 106 relative to the plate body 104. For instance, the first alignment groove 312 and second alignment groove 314 face “outward” and are centered along horizontal axis 502 of the plate body 104. The first alignment groove 312 and second alignment groove 314 of the frame assembly 106 include recessed regions dimensioned to coincide with corresponding protrusions of the base assembly 108. This design feature enables the frame assembly 106 to be attached to the base assembly 108 at a particular orientation and position, enhancing modularity of the system.

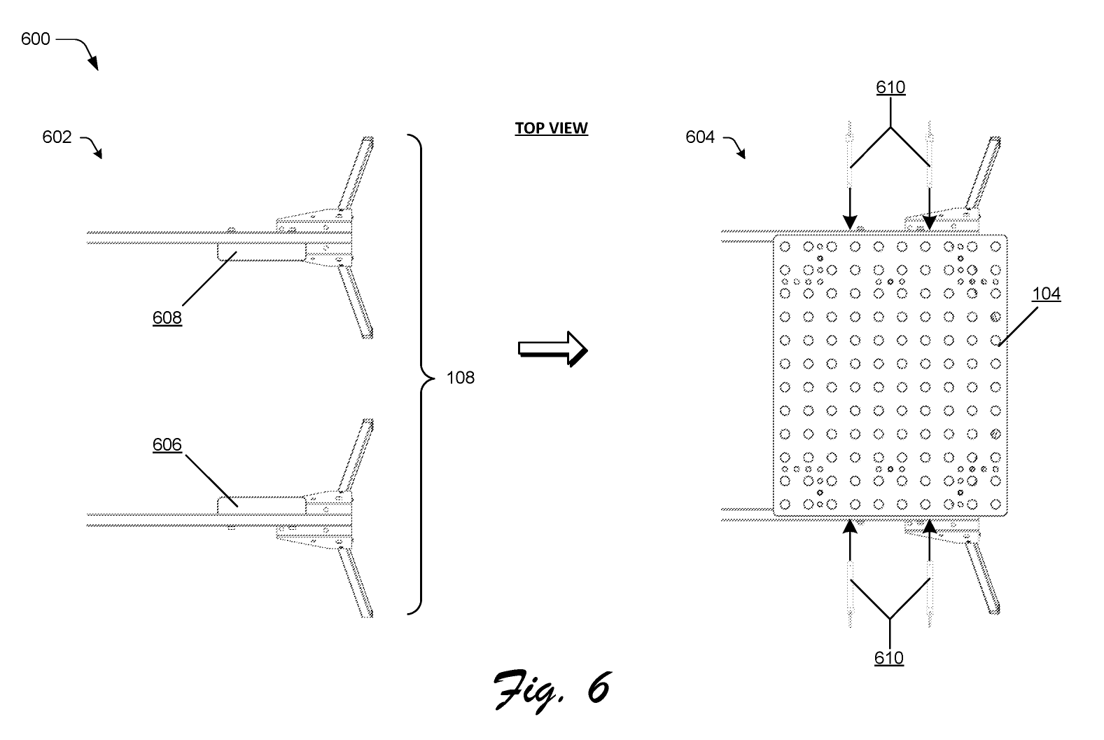

FIG. 6 depicts an example 600 of attaching a plate body 104, a frame assembly 106, and a base assembly 108 to one another in accordance with one or more implementations. The example 600 includes a first stage 602 and a second stage 604. As shown in the first stage 602, the base assembly 108 includes one or more alignment protrusions, such as a first alignment protrusion 606 and a second alignment protrusion 608. The alignment protrusions are positioned on the base assembly 108 to ensure precise and consistent attachment of the frame assembly 106 in a desired position and orientation.

For example, the first alignment protrusion 606 and second alignment protrusion 608 have a shape and dimensions that correspond to the recessed regions of the first alignment groove 312 and second alignment groove 314 of the frame assembly 106. For instance, the first alignment protrusion 606 and second alignment protrusion 608 have a rectangular shape with rounded ends and are sized to fit within the recessed regions of the first alignment groove 312 and second alignment groove 314 of the frame assembly 106. This complementary design allows for a secure fit and guides the frame assembly 106 into a desired position during assembly.

As shown in the second stage 604, the plate body 104, which is attached to the frame assembly 106, has been attached to the base assembly 108, such as via engagement of the alignment interface components, e.g., the first alignment groove 312 with the first alignment protrusion 606 and the second alignment groove 314 with the second alignment protrusion 608. In this way, the plate body 104 is positioned in a particular orientation with respect to the base assembly 108, such as positioned at an end of the base assembly 108 with a controlled amount of overhang. This configuration may be helpful for accommodating larger workpieces or providing additional workspace beyond the footprint of the base assembly 108.

In some implementations, the alignment protrusions and/or the alignment grooves may include additional features to enhance the connection between the base assembly and frame assembly. For instance, the first alignment protrusion 606 and second alignment protrusion 608 include perpendicular apertures that align and are dimensioned to coincide with corresponding apertures of the first alignment groove 312 and second alignment groove 314, which allows for insertion of pin assemblies such as quick-release pins and/or other fasteners to secure the components together. As depicted in the illustrated example, fasteners 610 are inserted through such perpendicular apertures to secure the plate body 104 and frame assembly 106 to the base assembly 108.

The fasteners 610 may be configured to disengage from the perpendicular apertures of the alignment protrusions and the perpendicular apertures of the alignment grooves to detach the frame assembly 106 from the base assembly 108. The fasteners 610 may take various forms to facilitate quick and secure attachment. In some implementations, the fasteners 610 may include one or more pin assemblies such as quick-release pins that can be rapidly inserted or removed without tools. The fastener 610 may include spring-loaded ball bearings or other locking mechanisms that allow for swift engagement and disengagement. Additionally or alternatively, the fasteners 610 may include one or more twist-lock pins, cam-lock fasteners, and/or other types of quick-connect hardware designed for tool-free operation. The quick-release functionality of these fasteners 610 may enable users to rapidly reconfigure the modular plate assembly 102 for different tasks or workpiece sizes, enhancing the overall versatility and efficiency of the system.

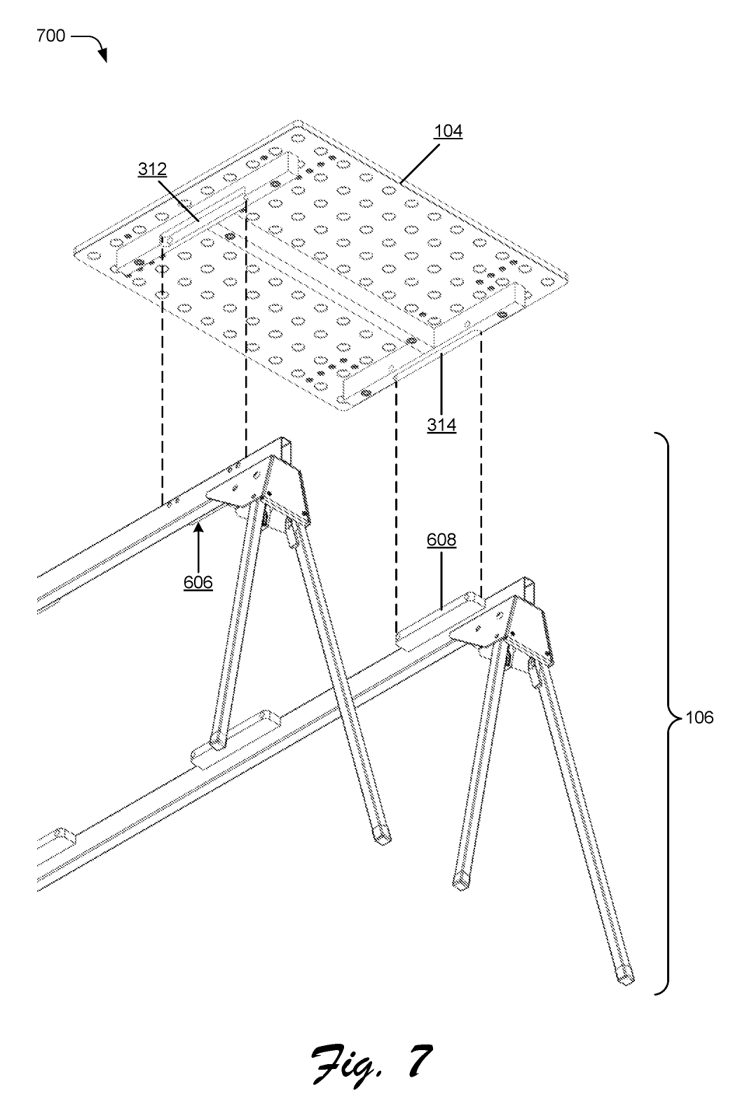

FIG. 7 depicts an additional view 700 of attachment of the plate body 104 and frame assembly 106 to the base assembly 108 in accordance with one or more implementations. The view 700, for instance, depicts alignment of the first alignment groove 312 with the first alignment protrusion 606 and alignment of the second alignment groove 314 with the second alignment protrusion 608. In this way, the plate body 104 is attachable in a desired orientation.

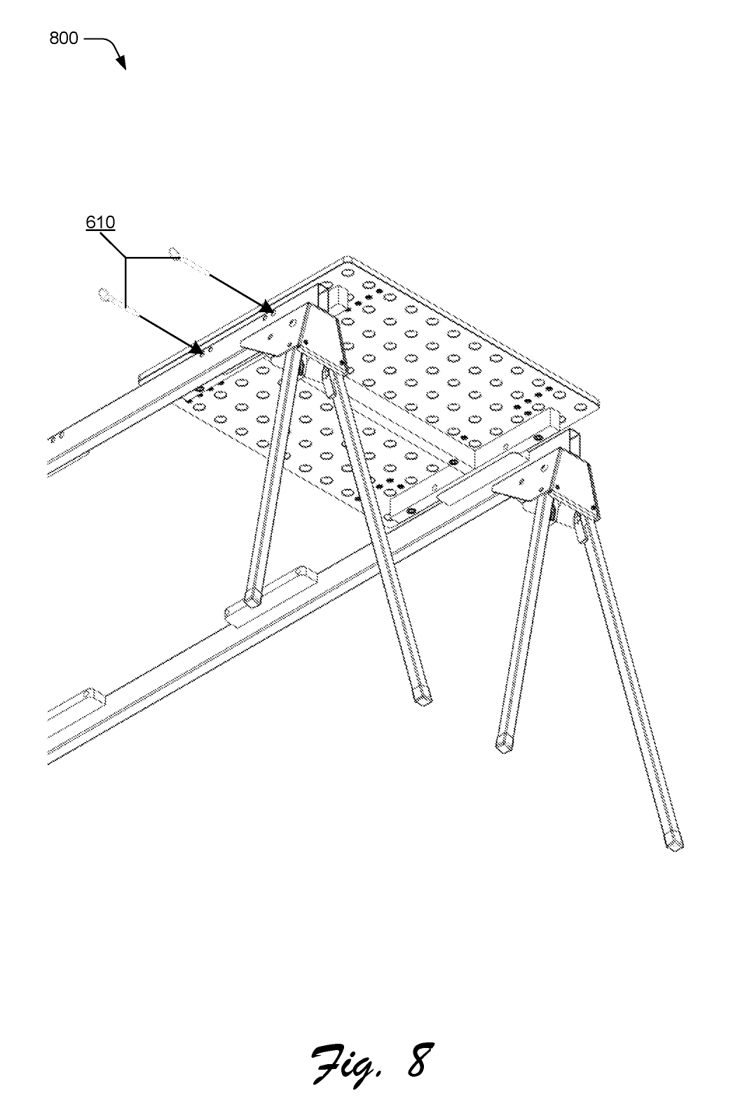

FIG. 8 depicts a view 800 of the plate body 104, the frame assembly 106, and the base assembly 108 attached to one another in a particular configuration in accordance with one or more implementations. The view 800 depicts insertion of fasteners 610 to attach the frame assembly 106 to the base assembly 108. The fasteners 610, for instance, are positionable along the one or more alignment members and are dimensioned to coincide with one or more perpendicular apertures, e.g., of the alignment components, to secure the base assembly 108 to the frame assembly 106.

Accordingly, the alignment system as depicted provides a precise and secure method for attaching the plate body 104 and frame assembly 106 to the base assembly 108 and ensures consistent positioning and orientation. This alignment system serves as a foundation for the modular nature of the modular plate assembly 102, which can be expanded and reconfigured in various ways to suit different applications and workspace requirements.

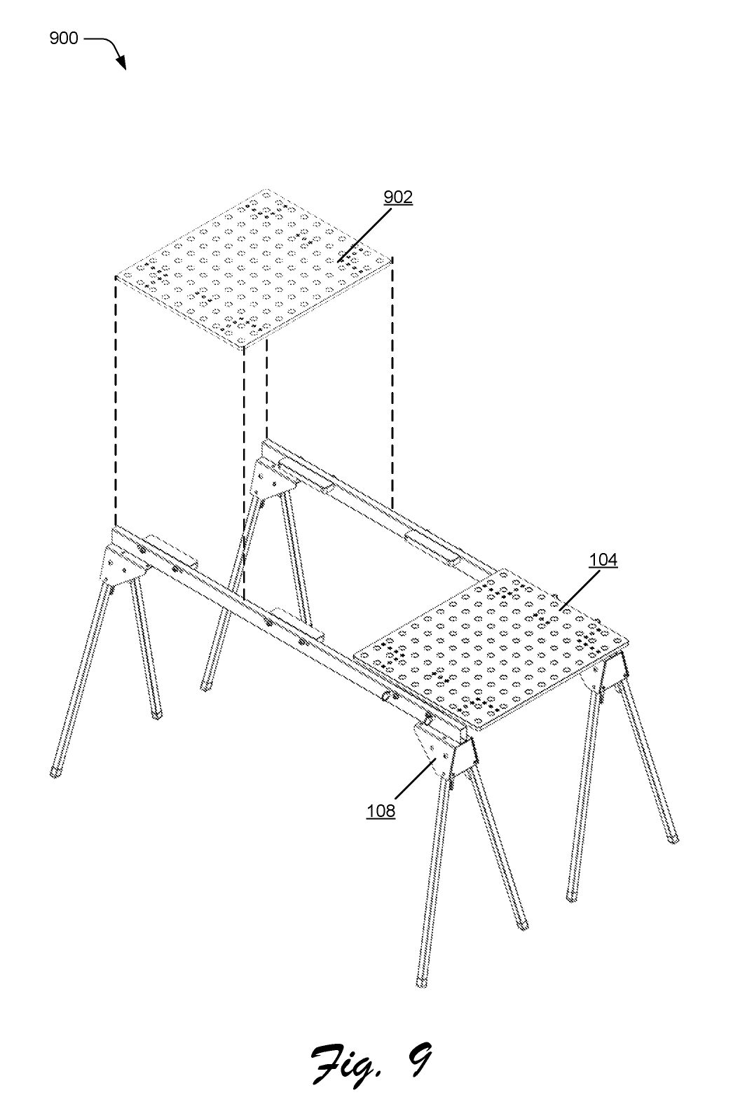

FIG. 9 depicts an example 900 of attachment of an additional plate body to a base assembly in accordance with one or more implementations. In various embodiments, the base assembly 108 may include additional mounting interfaces, e.g., configurations of attachment protrusions, that support attachment of a plurality of plate bodies 104. For instance, the base assembly 108 in the example 900 includes three attachment locations for plate bodies, each attachment location including a pair of alignment protrusions, to attach additional plate bodies.

For instance, the example 900 depicts the plate body 104 attached to the base assembly 108. The example 900 further depicts attachment of an additional plate body, e.g., a second plate body 902, to the other end of the base assembly 108. The plate body 104 and the second plate body 902 may be attached to a base assembly using alignment grooves and alignment protrusions as described in previous examples. The modular plate assembly 102 may allow for staggered arrangement of multiple plate bodies. This staggered configuration may intentionally create gaps in the welding table surface. These gaps may serve various purposes, such as allowing for cable management and/or providing access to an underside of a workpiece while clamped to the modular plate assembly 102.

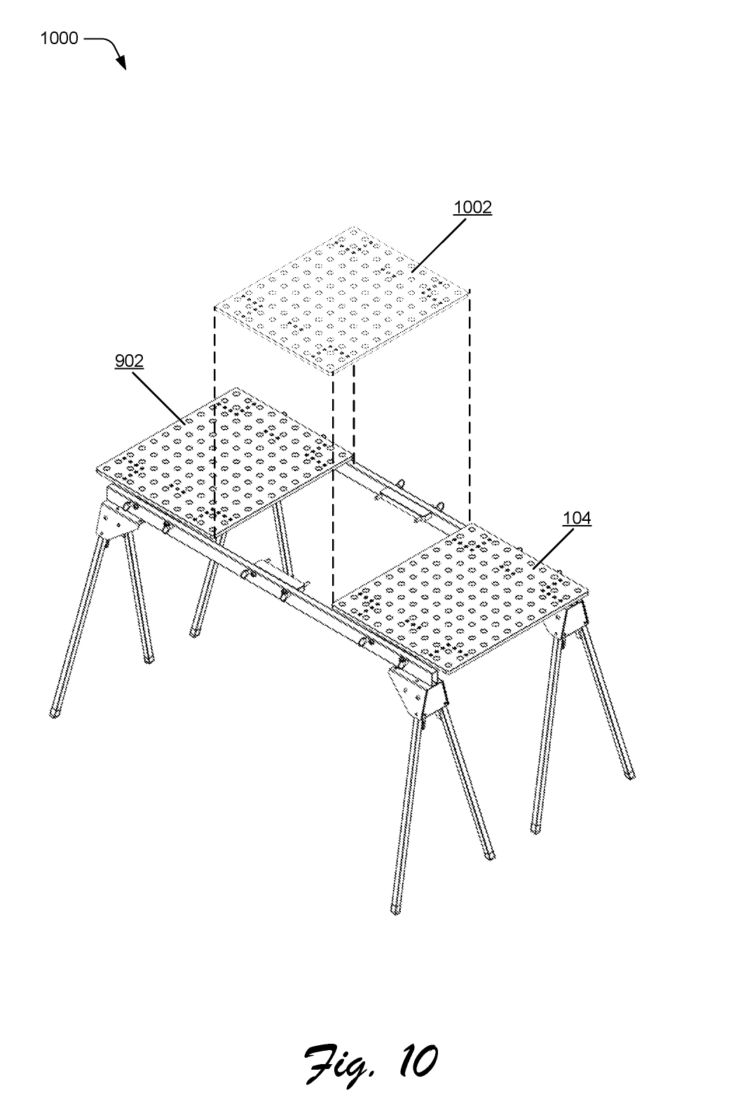

FIG. 10 depicts an additional example 1000 of attachment of additional plate bodies to a base assembly in accordance with one or more implementations. The example 1000 includes the plate body 104, the second plate body 902, and a third plate body 1002. For instance, the third plate body 1002 is attached to the base assembly 108 between the plate body 104 and the second plate body 902.

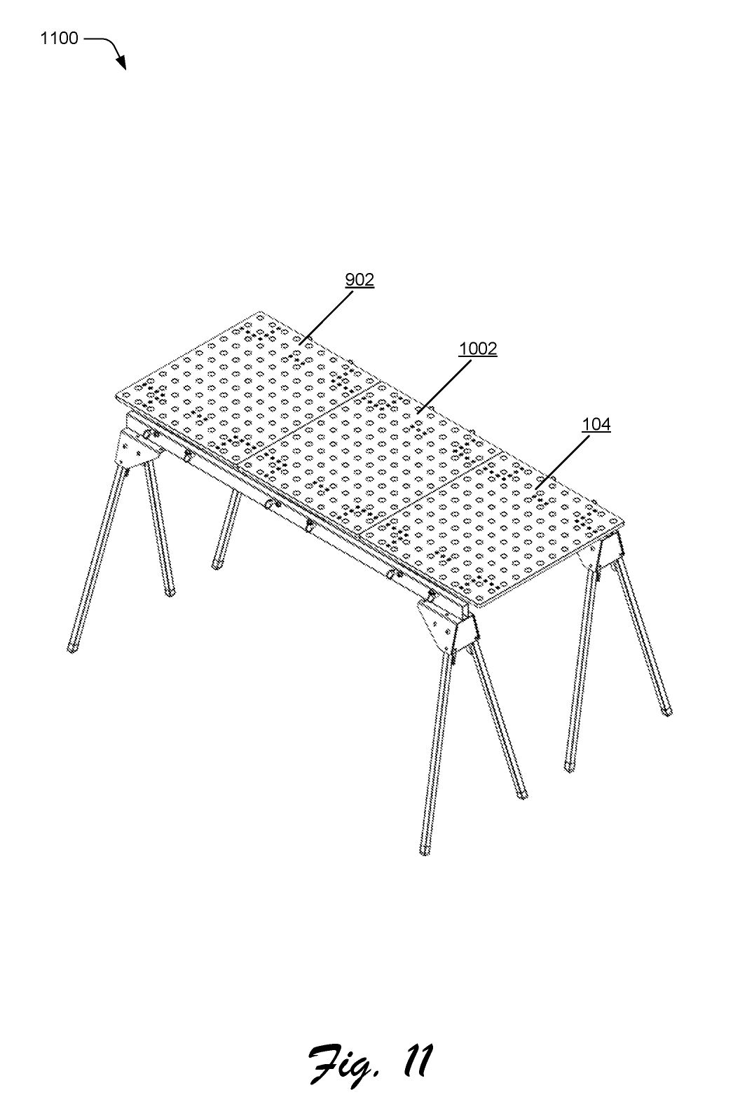

FIG. 11 depicts an example 1100 of the plate body 104, the second plate body 902, and the third plate body 1002 attached to form a relatively larger work surface in accordance with one or more implementations. In this example, the three plate bodies are attached flush to one another to create a large and continuous work surface. Thus, the modular nature of the plate bodies allows for flexible configuration of the work surface to accommodate various project sizes and requirements. The ability to combine multiple plate bodies offers advantages in terms of scalability and adaptability. For instance, users may expand a work surface as desired without replacement of the modular plate assembly 102 with an alternative modular plate assembly. Additionally, the modular design facilitates efficient transport and storage of relatively larger work surfaces, as the individual plate bodies 104 may be separated and moved independently.

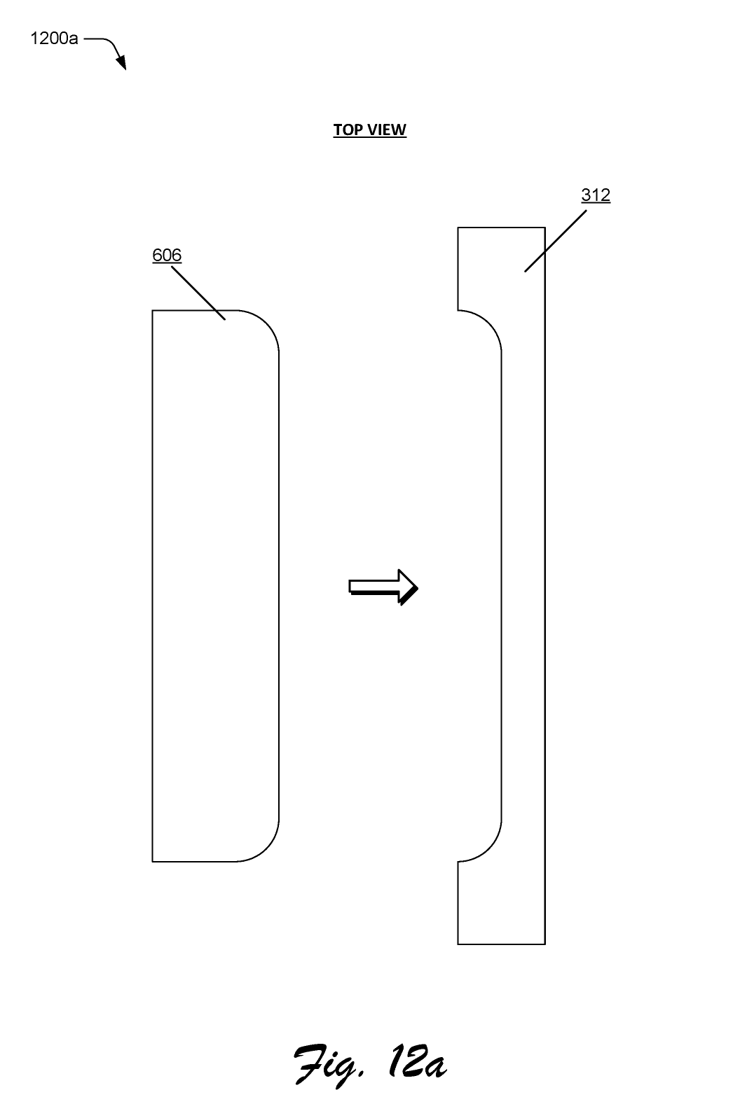

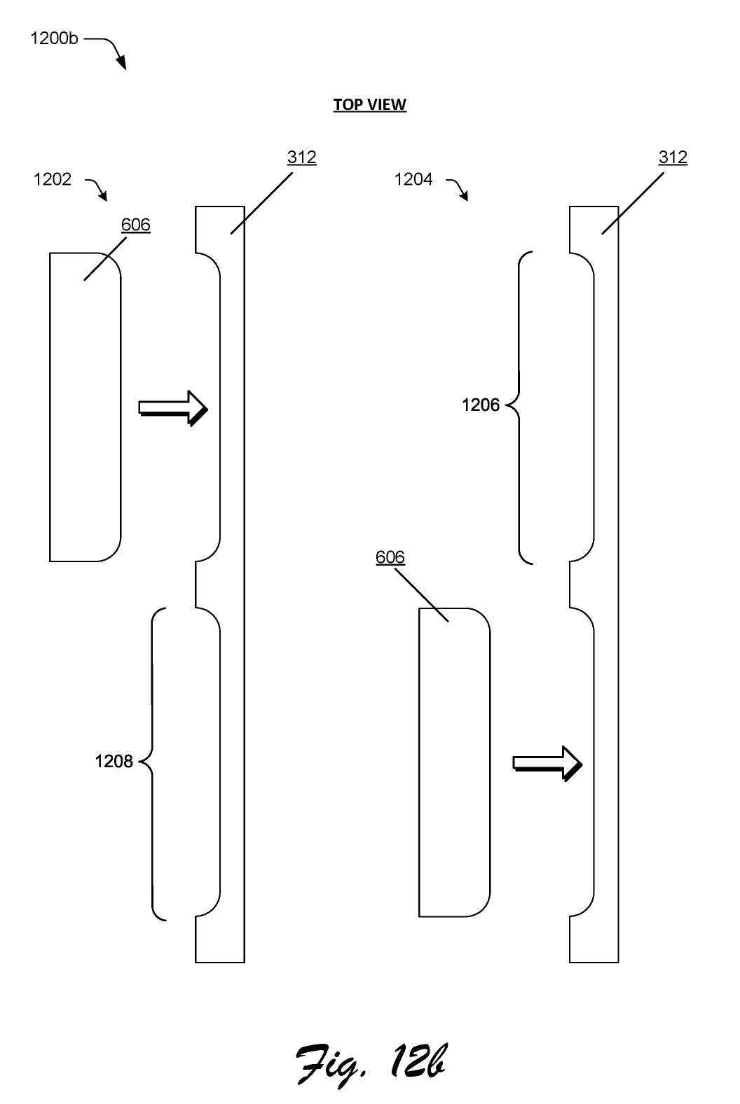

FIGS. 12a and 12b depict an example 1200a and an example 1200b of configurations of alignment system components in accordance with one or more implementations. For instance, FIG. 12a depicts a top view of a first alignment groove 312 and a first alignment protrusion 606. The first alignment groove 312 in this example has a rounded and tapered cross-sectional profile, and the first alignment protrusion 606 has a shape dimensioned to coincide with the shape of the first alignment groove 312.

For instance, the first alignment protrusion 606 has a rectangular body with rounded and/or tapered ends. The shape of the first alignment protrusion 606 is designed to complement and closely fit within the rounded and tapered cross-sectional profile of the first alignment groove 312. This complementary shape allows for smooth insertion and removal while maintaining a secure fit when engaged. The dimensions and curvature of the first alignment protrusion 606 may be precisely matched to the corresponding dimensions of the first alignment groove 312 to ensure proper alignment and stability when the components are assembled.

FIG. 12b depicts an example 1200b of additional configurations of components of the alignment system in accordance with one or more implementations in a first stage 1202 and a second stage 1204. In this example 1200b, the first alignment groove 312 includes multiple recessed regions, such as a first recessed region 1206 and a second recessed region 1208, that provide enhanced flexibility and precision in aligning and attaching components of the modular plate assembly 102.

In the first stage 1202, the first alignment protrusion 606 is aligned with the first recessed region 1206 to position the plate body 104 at a first position when attached to the base assembly 108. In the second stage 1204, the first alignment protrusion 606 is aligned with the second recessed region 1208, such as to position the plate body 104 at a second position relative to the base assembly 108. This configuration with multiple recessed regions supports stepped and/or incremental positioning of the modular plate assembly 102, such as to provide various attachment points and/or orientations of the plate body 104 relative to the base assembly 108. The ability to adjust the position of the modular plate assembly 102 relative to the base assembly 108 supports enhanced versatility of the modular plate assembly 102 and allows users to modify the work surface configuration for different project requirements or workspace constraints.

A variety of shapes and configurations for the alignment system components, e.g., the alignment grooves and/or alignment protrusions, are considered. In some implementations, the alignment grooves (and/or the corresponding alignment protrusions) may have one or more of a dovetail shape, T-shaped cross-section, V-shaped profile, keyhole configuration, or stepped rectangular profile, to provide various advantages in terms of alignment precision, ease of engagement, and resistance to lateral forces. Further, in some implementations the base assembly 108 includes one or more alignment grooves and/or the frame assembly 106 includes one or more alignment protrusions.

In at least one example, an alignment groove includes a series of detents or notches along a length of the alignment groove that correspond to protrusions and/or spring-loaded balls/pins of an alignment protrusion. This arrangement may provide tactile feedback and multiple secure positions as the frame assembly 106 is attached to the base assembly 108, allowing for fine adjustments in the positioning of the plate body 104. In some implementations, the alignment grooves and/or protrusions may have different depths or profiles, allowing for a variety of engagement levels or locking positions. This multi-tiered design may enable fine-tuning of position and orientation of the plate body 104, enhancing the overall versatility of the modular plate assembly.

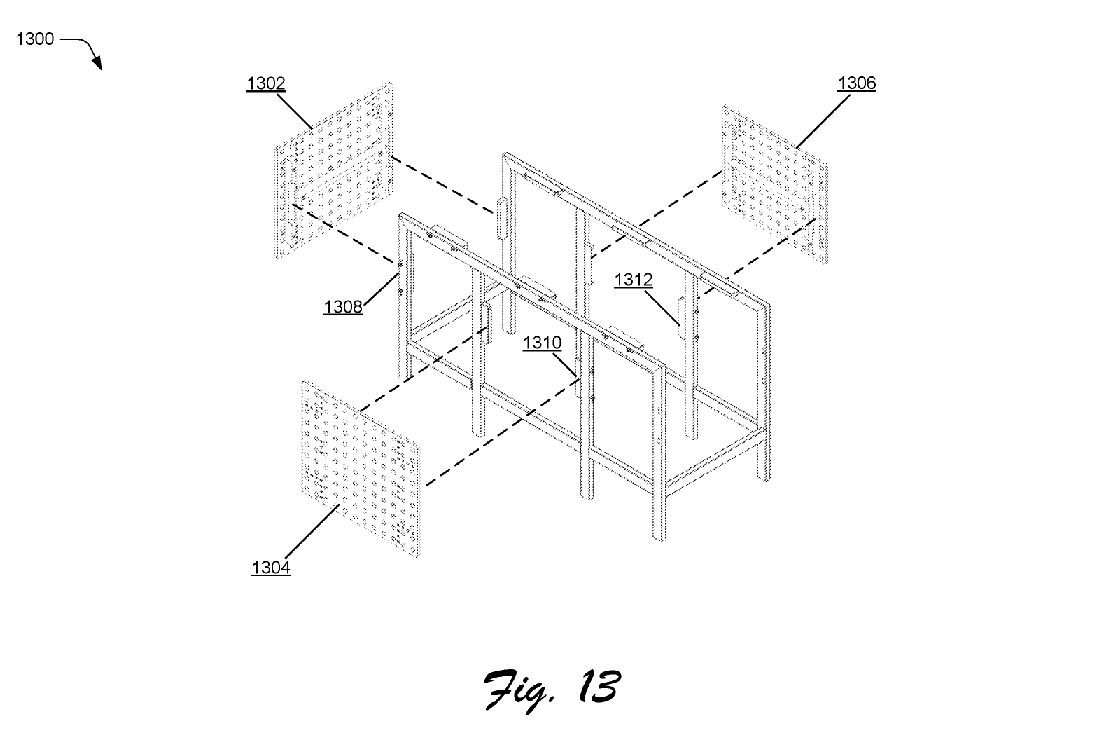

FIG. 13 depicts an example 1300 of a modular plate assembly with multiple plate bodies attached to a base assembly 108 in accordance with one or more implementations. In this example 1300, the base assembly 108 includes multiple attachment interfaces on various faces, allowing for connection of plate bodies 104 at the ends, along the sides, and along a top surface of the base assembly 108.

For instance, each plate body depicted may include alignment members with alignment grooves that correspond to alignment protrusions on the base assembly 108. This system may ensure precise positioning and secure attachment of each plate body. This configuration provides for a variety of modular arrangements, with the base assembly 108 including multiple sets of alignment protrusions positioned to accommodate plate bodies in different orientations and positions.

For instance, a first plate body 1302, a second plate body 1304, and a third plate body 1306 are depicted as aligned with different sets of alignment protrusions of the base assembly 108. The first plate body 1302, for instance, may be attached to an end 1308 of the base assembly 108. The second plate body 1304 may be attached to a first side 1310 of the base assembly 108, while the third plate body 1306 may be attached to a second side 1312 of the base assembly 108.

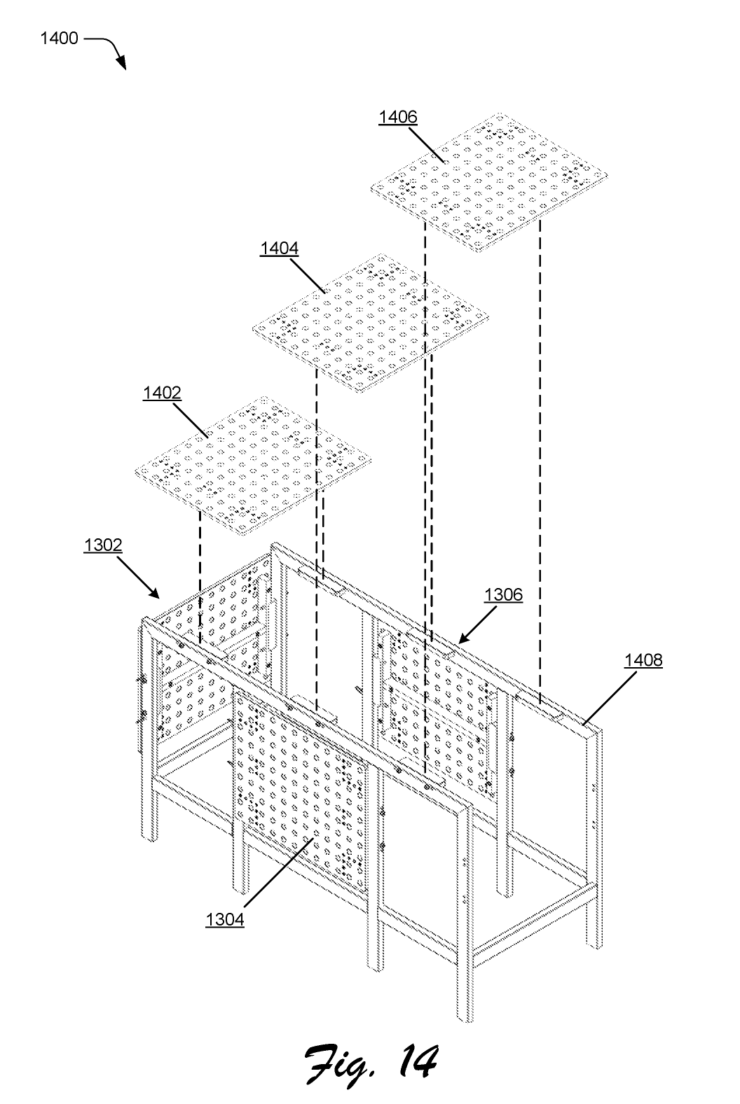

FIG. 14 depicts an additional example 1400 of a modular plate assembly 102 with multiple plate bodies attached to a base assembly in accordance with one or more implementations. The example 1400, for instance, is a continuation of the example 1300. For instance, FIG. 14 depicts the first plate body 1302, second plate body 1304, and third plate body 1306 attached to the base assembly 108.

This example 1400 further depicts a fourth plate body 1402, a fifth plate body 1404, and a sixth plate body 1406 that are attachable to a top surface 1408 of the base assembly 108. For instance, the fourth plate body 1402 is attached adjacent to the first plate body 1302, the fifth plate body 1404 is attached between the second plate body 1304 and the third plate body 1306, and the sixth plate body 1406 is attached adjacent to the fifth plate body 1404.

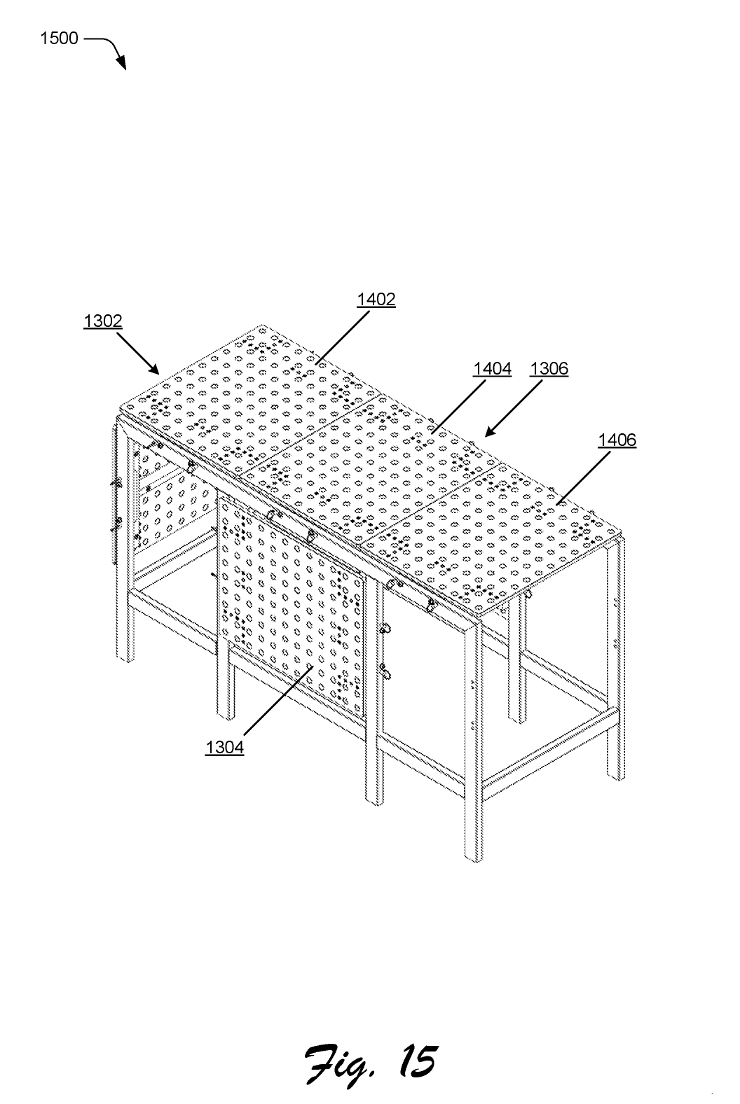

FIG. 15 depicts an example 1500 of an assembled modular plate assembly 102 with multiple plate bodies attached in accordance with one or more implementations. The example 1500, for instance, is a continuation of the examples 1300 and 1400. For instance, FIG. 15 depicts the first plate body 1302, second plate body 1304, third plate body 1306, fourth plate body 1402, fifth plate body 1404, and sixth plate body 1406 attached to the base assembly 108 at various positions. In this configuration, the multiple plate bodies are connected to create an expansive and continuous work area. The modular nature of this arrangement allows for customization of the work surface size and shape based on specific project demands or workspace requirements.

The large-scale modular configuration depicted may provide several advantages. The ability to combine multiple plate bodies may allow users to create expansive work surfaces for larger projects. The modular design may also facilitate transportation and storage of the system, as individual plate bodies can be detached and moved separately. Additionally, users may have the flexibility to add or remove plate bodies as needed, adapting the work surface to different project requirements.

FIG. 16 depicts an example 1600 of a standalone configuration for a plate body in accordance with one or more implementations in a first stage 1602 and a second stage 1604. In some examples, the plate body 104 may be configured for standalone use, such as without attachment to the frame assembly 106 and/or the base assembly 108. For instance, the second aperture configuration 204 enables attachment of leveling feet 1606 directly to the plate body 104.

By way of example, the first stage 1602 depicts the plate body 104 with four leveling feet 1606 aligned with corresponding apertures of the second aperture configuration 204. As depicted in the second stage 1604, the leveling feet 1606 are secured to the bottom surface 112 via apertures 114 of the second aperture configuration 204. In an example, the leveling feet 1606 are adjustable and include threaded shafts that engage with threaded apertures in the second aperture configuration 204, enabling height adjustment of each foot individually. In some examples, the leveling feet 1606 are adjustable to allow for precise leveling of the plate body 104 on uneven surfaces.

Accordingly, an ability to quickly attach and detach the leveling feet 1606 allows for flexible use of the plate body 104. For instance, users may transition between standalone use and integration of the plate body 104 with a fully assembled modular plate assembly 102 (e.g., the modular plate assembly as including the base assembly 108) as desired, such as to enhance versatility of the system. In this way, the plate body 104 is portable and may be used in various locations independently of a base assembly 108. For example, the plate body 104 with attached leveling feet 1606 may be placed on a truck tailgate and/or other temporary work surface, providing a stable and level welding platform in field conditions.

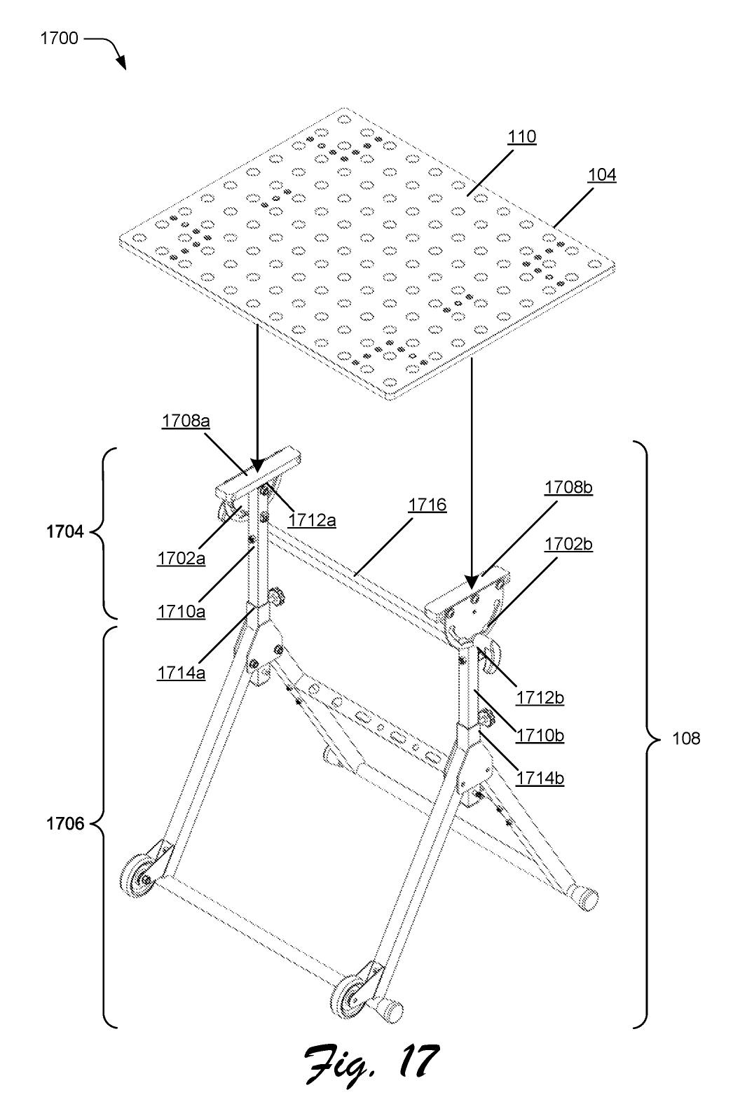

FIG. 17 depicts an example 1700 of a modular plate assembly 102 that includes one or more rotational components in accordance with one or more implementations. In various embodiments, the alignment system supports attachment of the plate body 104 and/or the frame assembly 106 to base assemblies 108 with various properties and/or functionality. In this example, the base assembly 108 is depicted to include a frame structure with multiple interconnected members and rails that support modular and portable functionality. The base assembly 108 is further depicted to include a rotational component 1702 (depicted as a first rotational component 1702a and a second rotational component 1702b), an extendible neck 1704, and foldable legs 1706.

The rotational components 1702a, 1702b for instance, are illustrated as attached to alignment protrusions 1708a, 1708b. In some examples, the rotational components 1702a, 1702b are locking components, such that the rotational components 1702a, 1702b are configurable to position the plate body 104 at multiple rotational orientations relative to the base assembly 108, such as to provide enhanced flexibility and functionality to the modular plate assembly 102 by allowing adjustment to an orientation of the work surface to accommodate different welding positions, improve ergonomics, or optimize access to hard-to-reach areas of a workpiece. This is useful, for instance, for tasks that involve welding at unconventional angles or when working on complex three-dimensional structures.

The extendible neck 1704 includes a pair of vertical members, e.g., a vertical member 1710aand a vertical member 1710b, that are substantially parallel to one another. In this configuration, the vertical members are substantially perpendicular to the top surface 110 of the plate body 104. Proximal ends 1712a, 1712b of the vertical members 1710a, 1710b are attached to rotational components 1702a, 1702b and/or one or more alignment protrusions 1708a, 1708b. Distal ends 1714a, 1714b of the vertical members 1710a, 1710b, are attached to the foldable legs 1706. The vertical members 1710a, 1710b further can include one or more horizontal supports, e.g., the horizontal support 1716 that is attached substantially perpendicular to the vertical members 1710a, 1710b.

The extendible neck 1704 may allow for height adjustment of the plate body 104 relative to the base assembly 108, e.g., along a vertical axis of the vertical members 1710a, 1710b. In this way, the extendible neck 1704 provides enhanced ergonomic flexibility, such as to support adjustability of a height of the work to accommodate different user heights and working positions, thereby reducing strain, and improving comfort during fabrication. In at least one example, the extendible neck 1704 includes one or more adjustment knobs to control a position of the plate body 104 along the vertical axis of the vertical members 1710a, 1710b.

The foldable legs 1706 in this example 1700 provide a collapsible design for the base assembly 108, such as to facilitate storage and transport of the modular plate assembly 102. For instance, the foldable legs 1706 can fold “together” such as to reduce an overall size of the modular plate assembly 102. The base assembly 108 further can include casters and/or wheel components, such as to facilitate efficient transportation of the modular plate assembly 102.

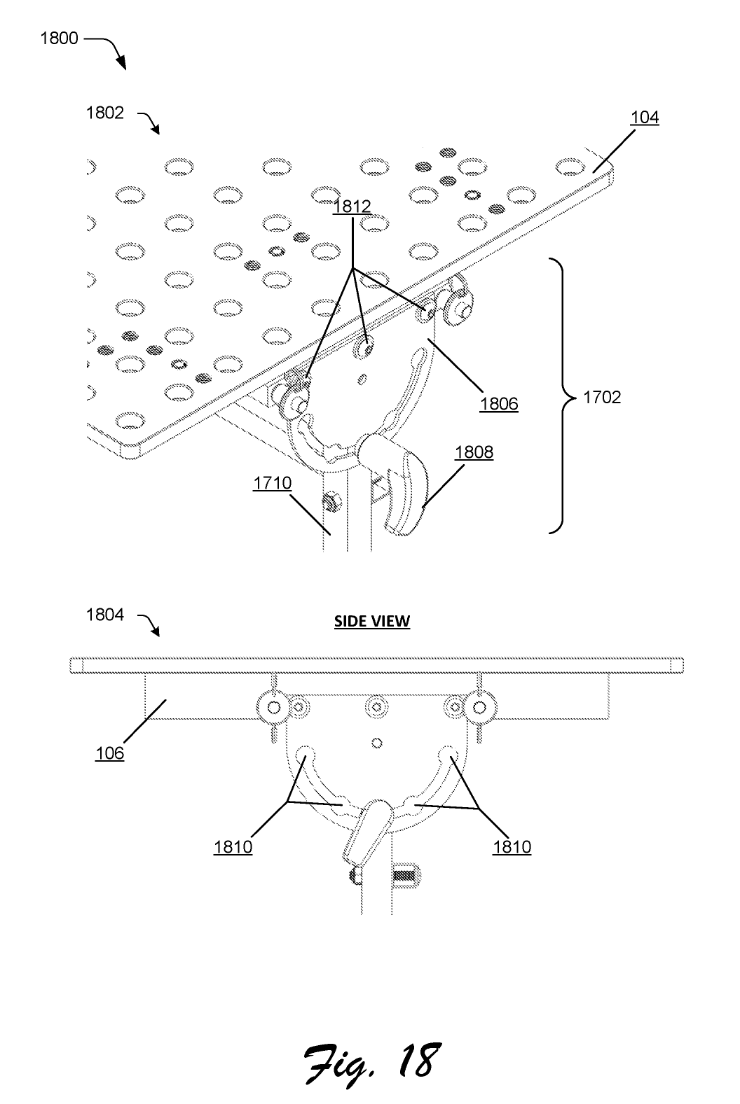

FIG. 18 depicts an example 1800 of a rotational component 1702 in accordance with one or more implementations in a first view 1802 and a second view 1804. As shown in the first view 1802 and the second view 1804, the rotational component 1702 may include a mounting bracket 1806, an engagement component 1808, and multiple locking points 1810. For example, the engagement component 1808 can be disposed within a cavity of the mounting bracket 1806 and may be positioned at one or more of the locking points 1810 to secure (e.g., to “lock”) positioning of the plate body 104 at various angles.

The mounting bracket 1806 may be configured to attach to one or more of the plate body 104, the frame assembly 106, and/or the base assembly 108. For instance, in the illustrated example, the rotational component 1702 is laterally attached to the frame assembly 106 by one or more fasteners 1812. The rotational component 1702 may further be attached to the base assembly 108, such as via one or more additional fasteners. In this way, when the plate body 104 and frame assembly 106 are removed from the base assembly 108, the rotational component 1702 may be attached to (e.g., remain with) either the base assembly 108 or the plate body 104 and/or frame assembly 106.

The engagement component 1808 further may be designed to interface with the base assembly 108. For instance, the engagement component 1808 is insertable through a cavity of the rotational component 1702, depicted here as a semicircular aperture with regularly spaced circular locking points 1810, and is further dimensioned to coincide with an aperture located on the base assembly 108, e.g., an aperture positioned on an outside surface of a vertical member 1710. The engagement component 1808 can include a variety of components, such as but not limited to a spring-loaded pin, ball bearing mechanism, a quick-release lever, one or more buttons, and so forth.

The locking points 1810 may be positioned around the circumference of the rotational component 1702 to secure the plate body 104 at various rotational positions. As depicted in FIG. 18, the locking points 1810 are arranged in a semicircular pattern with five evenly spaced apertures that allow the engagement component 1808 to lock the plate body 104 at particular angles. In various implementations, the locking points 1810 may be configured with different spacing intervals, such as at 15-degree, 30-degree, or 45-degree increments, to provide varying levels of rotational precision. Additionally, the locking points 1810 may include detents, spring-loaded ball bearings, or other mechanical features to provide tactile feedback and enhanced stability when the plate body 104 is positioned at a particular rotational orientation.

In some implementations, the rotational component 1702 may incorporate one or more alternative or additional mechanisms to provide precise and versatile angle control for the plate body 104. In at least one example, the rotational component 1702 includes a gear system, e.g., a worm gear system, that supports continuous angle adjustments. The modular plate assembly 102 may also include a motorized rotation mechanism that supports electronic control and rotation of the plate body 104. For instance, the modular plate assembly 102 may include a digital angle readout and/or preset angle options, such as to allow users to quickly and accurately configure the plate body 104 at desired angles for repeated operations or complex welding sequences. Additionally or alternatively, the rotational component 1702 may integrate a hydraulic or pneumatic system for smooth and controlled angle adjustments. This system may allow users to adjust discrete angles of the plate body 104 while supporting heavy workpieces, providing stability and precision in positioning.

In some examples the rotational component 1702 supports rotation of one or more components of the modular plate assembly 102 about multiple axes. In an example, the rotational component 1702 includes a dual-axis rotation mechanism, such as to allow the plate body 104 to rotate around a vertical axis as well as one or more additional axes. This configuration may include a second set of locking points arranged perpendicular to the first set, enabling the plate body 104 to tilt forward or backward. Additionally or alternatively, the rotational component 1702 may incorporate a ball-and-socket joint mechanism, providing multi-directional angle adjustments. This configuration may allow the plate body 104 to be positioned at compound angles and combine rotations around multiple axes simultaneously. Such flexibility can be advantageous when working on intricate three-dimensional structures or performing welding tasks in confined spaces.

In at least one embodiment, the modular plate assembly 102 includes interchangeable rotational components with different angle adjustment capabilities. For instance, users may “swap” different rotational components 1702 for different use cases, such as to switch between a primary rotational component 1702 with fine-grained angle control, e.g., that includes locking points at five-degree increments and a secondary rotational component 1702 that allows for quick 90-degree rotations. Thus, the rotational component 1702 provides enhanced customization options for the modular plate assembly 102.

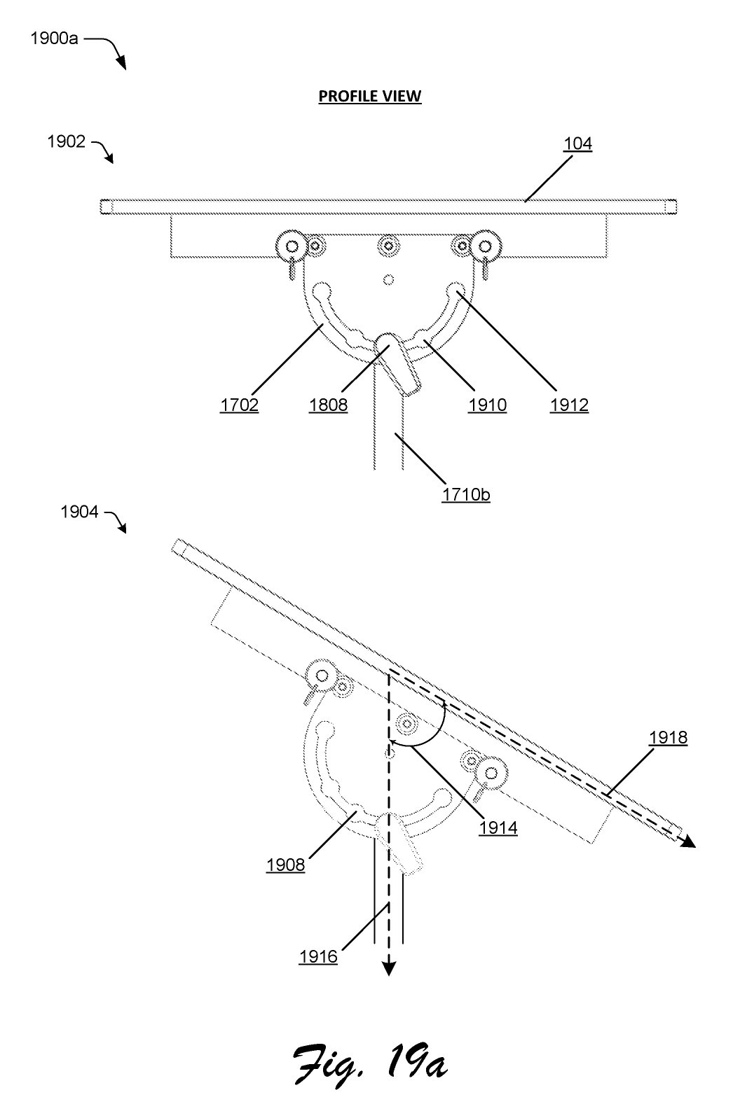

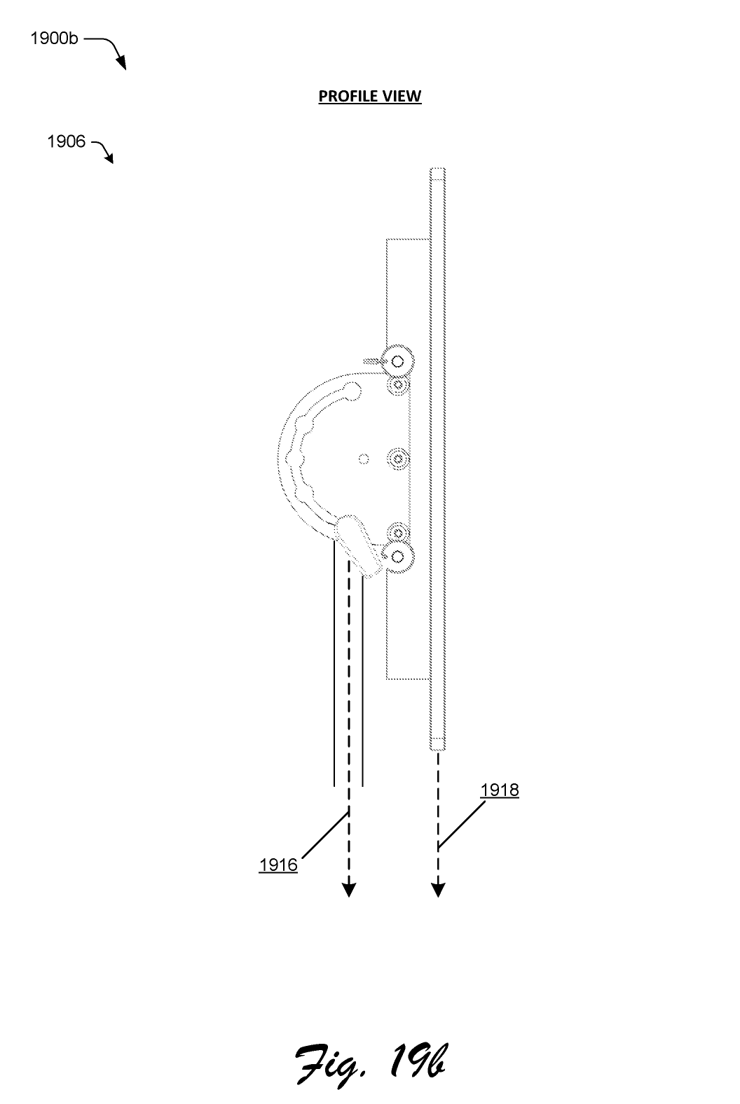

FIGS. 19a and 19b depict examples 1900a and 1900b of rotation of the modular plate assembly 102 about the rotational component 1702 in accordance with one or implementations in a first position 1902, a second position 1904, and a third position 1906. In the first position 1902, the engagement component 1808 is engaged with a first aperture 1908 that represents a central locking point 1810 of the mounting bracket 1806, and the plate body 104 is disposed substantially perpendicular to a vertical member of the base assembly 108, e.g., the vertical member 1710b.

In the second position 1904, the engagement component 1808 is engaged with a second aperture 1910 that represents a second locking point 1810 to position the plate body 104 at an angled position relative to the vertical member 1710b. For instance, an angle 1914 formed between a vertical axis 1916 of the vertical member 1710b and an axis 1918 of the plate body 104 is an acute angle, approximately 45 degrees.

In the third position 1906, the engagement component 1808 is engaged with a third aperture 1912 that represents a third locking point 1810 to position the plate body 104 substantially parallel to the vertical member 1710b. For instance, the plate body 104 has been rotated approximately 90 degrees, such that the vertical axis 1916 is substantially parallel to the axis 1918. This configuration allows for vertical positioning of the work surface, which may be advantageous for various welding operations that demand access to the workpiece from a different orientation and/or for transportation of the modular plate assembly 102.

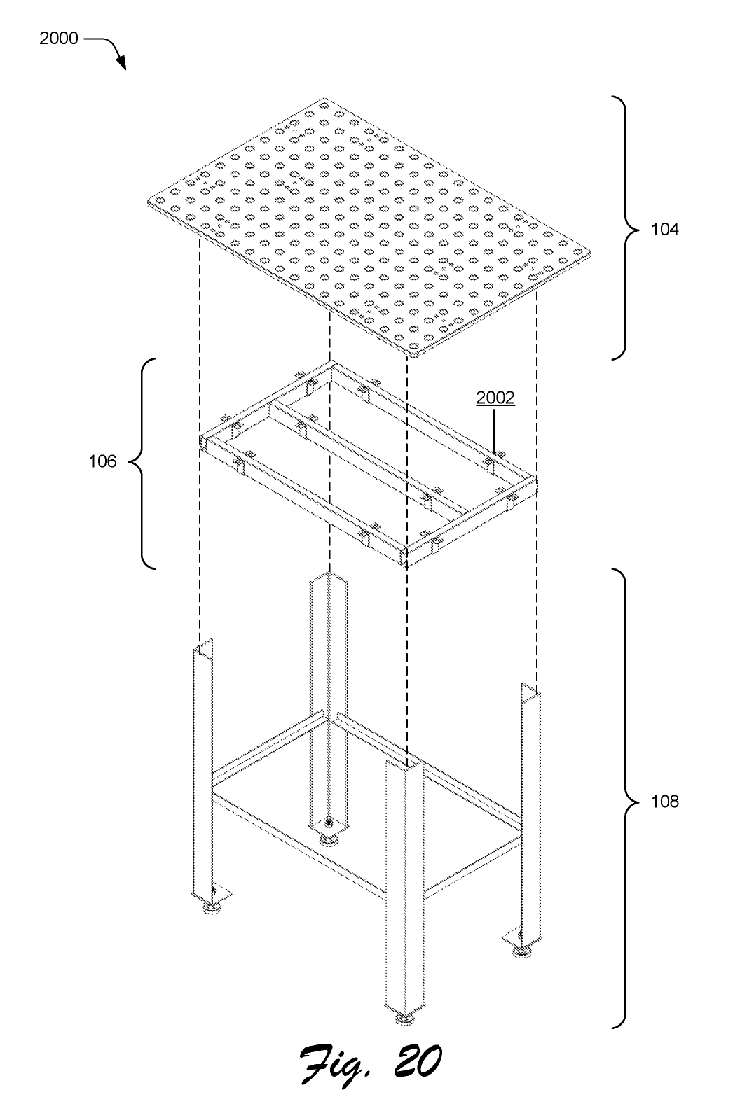

FIG. 20 depicts an example 2000 of a leveling system of a modular plate assembly 102 in accordance with one or more implementations. In some examples, the modular plate assembly 102 may include a leveling system that enables adjustment of one or more portions of the plate body 104 relative to the frame assembly 106. This adjustment capability may enable fine-tuning of the plate body 104 orientation to achieve a level surface for various tasks.

In the illustrated example 2000, the plate body 104, frame assembly 106, and base assembly 108 are depicted as aligned and disengaged from one another. The frame assembly 106 in this example includes various leveling components 2002 of a leveling system. Each leveling component 2002, for instance, is operable to adjust a position and/or orientation of one or more portions of the plate body 104 relative to the frame assembly 106, such as through a combination of pulling and pushing forces applied at strategic points along an interface between these components.

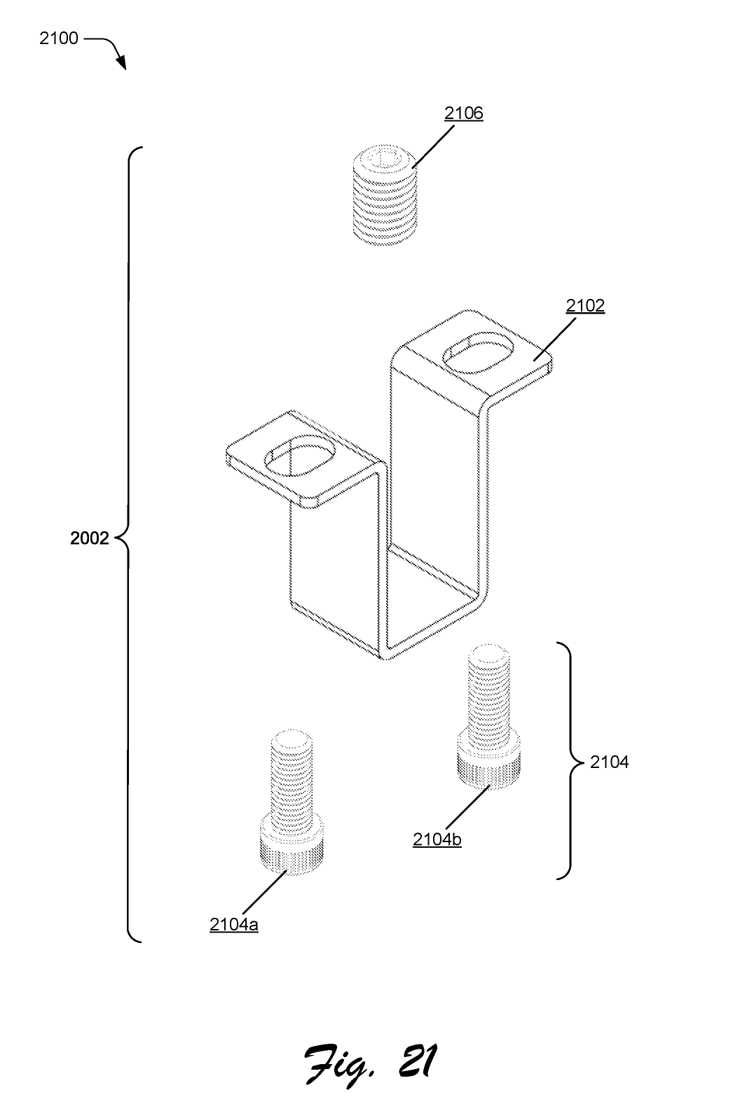

FIG. 21 depicts an example 2100 of a leveling component 2002 of a modular plate assembly 102 in accordance with one or more implementations. The leveling component 2002 may include a mounting bracket 2102, one or more fasteners 2104, and one or more leveling screws 2106. These components are configurable to enable adjustment of a plate body 104 relative to a frame assembly 106.

For instance, the mounting bracket 2102 may be dimensioned to partially surround a member and/or rail of the frame assembly 106. In some cases, the mounting bracket 2102 may have a U-shaped profile or other suitable configuration to accommodate different frame member geometries. By way of example and not limitation, the mounting bracket 2102 may have a V-shaped profile to accommodate angled frame members or an L-shaped profile for corner attachments. In some implementations, the mounting bracket 2102 may feature adjustable or interchangeable inserts to adapt to various frame member cross-sections, allowing for versatility in accommodation of different frame assembly 108 designs.

The mounting bracket 2102 further can include one or more apertures that are dimensioned to house one or more fasteners 2104. These apertures may be threaded or unthreaded and may be arranged in various patterns to accommodate different frame member geometries. For example, the mounting bracket 2102 may include a linear arrangement of apertures for straight frame members or a curved arrangement for rounded frame members, providing flexibility in how the bracket interfaces with different components of the frame assembly.

In at least one example, the mounting bracket 2102 includes one or more extendible wings that can be deployed to provide additional surface area for leveling operations. These extendible wings may slide or fold out from the main body of the mounting bracket 2102 to increase a contact area with the frame member 2302 and/or the bottom surface 112 of the plate body 104, such as to distribute forces evenly and enhance stability during fine adjustments.

The extendible wings, for instance, may include additional apertures for supplementary fasteners, which support precise control over the leveling process by creating multiple points of adjustment within a single mounting bracket 2102. This configuration is advantageous, for instance, in embodiments that include relatively large plate bodies 104 and/or to address localized warping, such as to enable granular control over particular regions of the plate body 104 without installation of additional leveling components 2002. Accordingly, various shapes and configurations of the mounting bracket 2102 are considered to provide advantages such as increased stability, enhanced load distribution, and/or improved accessibility for adjustment in confined spaces.

The fasteners 2104 may include a first fastener 2104a and a second fastener 2104b. These fasteners 2104 may serve as attachment pins insertable into apertures of the mounting bracket 2102 and one or more apertures of the plate body 104. The fasteners may provide a force in a first direction along vertical axes perpendicular to a top surface of the plate body 104, such as to secure the frame member to a bottom surface of the plate body 104. For example, the fasteners 2104 include threads that are dimensioned to coincide with corresponding threads of apertures of the mounting bracket 2102 and/or the plate body 104.

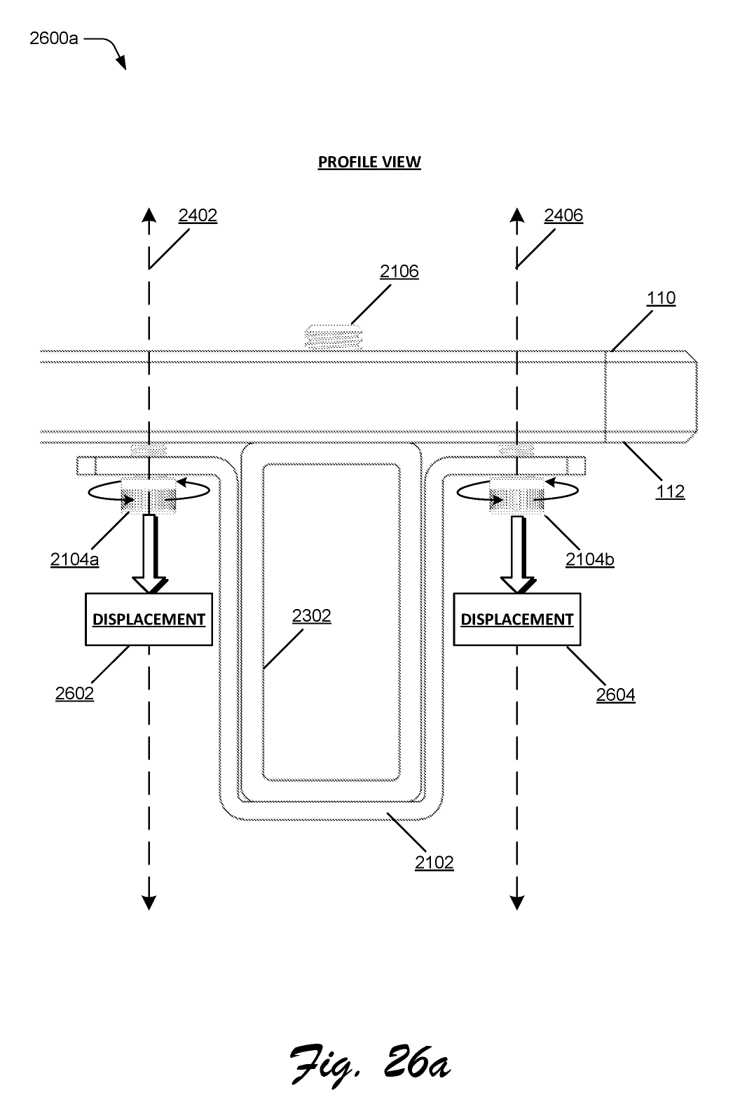

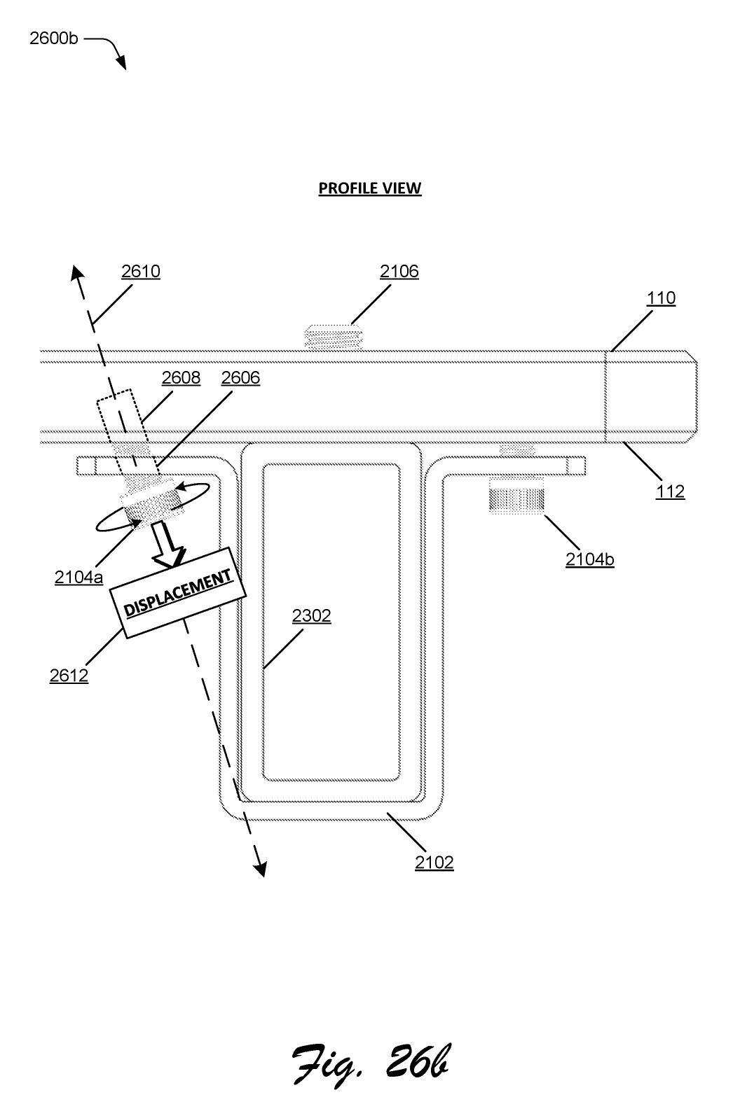

The leveling screw 2106 may be actuatable to apply a force in a second direction along a vertical axis to adjust a position of the plate body 104 relative to the frame assembly 106. For instance, the leveling screw 2106 may include threads that are dimensioned to coincide with corresponding threads of the plate body 104. In some examples, the second direction is substantially opposite the first direction. Additionally or alternatively, the force applied by the leveling screw 2106 may be spatially offset from the forces applied by the fasteners 2104. This arrangement may allow for fine-tuning of the plate body 104 position through a combination of multidirectional forces. In some examples, one or more of the leveling screw 2106 and/or the fasteners 2104 are insertable at an angle, such as to provide one or more angled forces as discussed below with respect to FIG. 26b.

FIG. 22 depicts a top view 2200 of apertures of the plate body 104 in accordance with one or more implementations. The view 2200, for instance, depicts how components of the leveling system connect to apertures of the plate body 104. As described above, in some examples the plate body 104 includes a first aperture configuration 202 (shown with white circles) and a second aperture configuration 204, shown in this example as relatively smaller black circles.

In this example, the second aperture configuration 204 includes one or more leveling groups 2202. Each leveling group 2202 may correspond to a respective leveling component 2002 and may include multiple apertures 114, such as a first leveling aperture 2204, a second leveling aperture 2206, and a third leveling aperture 2208. The first leveling aperture 2204 and the third leveling aperture 2208 may facilitate attachment of the mounting bracket 2102 to the bottom surface of the plate body 104 by the fasteners 2104, such as with a frame member disposed within an interior portion of the mounting bracket 2102.

For instance, the first leveling aperture 2204 is dimensioned to coincide with the first fastener 2104a, and the third leveling aperture 2208 is dimensioned to coincide with the second fastener 2104b. In this way, the first fastener 2104a is insertable through an aperture of the mounting bracket 1806 into the first leveling aperture 2204 from the bottom surface 112 of the plate body 104. Similarly, the second fastener 2104b is insertable through an additional aperture of the mounting bracket 1806 into the third leveling aperture 2208 from the bottom surface 112 of the plate body 104.

The second leveling aperture 2206 may support engagement of the leveling screw 2106 with the plate body 104 and/or the frame assembly 106. For instance, the second leveling aperture 2206 is dimensioned to coincide with the leveling screw 2106. Accordingly, the leveling screw 2106 is insertable into the second leveling aperture 2206, such as to apply a force onto a frame member of the frame assembly 106.

A variety of orientations, number, and position of the leveling groups 2202 are considered. In the illustrated example, the leveling groups 2202 are arranged at intervals adjacent to a perimeter of the top surface 110 of the plate body 104, e.g., two leveling groups 2202 per side of the plate body 104. The plate body 104 further includes two leveling groups 2202 along a midline of the plate body 104, such as to attach to a central frame member of the frame assembly 106. This arrangement may allow for strategic placement of leveling components 2002 to provide comprehensive adjustment capabilities across the plate body 104.

In some implementations, the spacing and arrangement of the leveling groups 2202 may vary to accommodate different plate body sizes, shapes, or specific leveling requirements. For instance, the leveling groups 2202 may be positioned in a grid pattern across the surface of the plate body 104, such as to allow for various localized adjustments in a number of positions. Alternatively or additionally, the leveling groups 2202 may be concentrated in areas that are more prone to warping or stress, such as corners or high-load regions. In at least one example, multiple leveling groups 2202 are positioned in a row and configured with alternating offsets.

In some implementations, the plate body 104 may include leveling groups 2202 in central areas to provide support and adjustment capabilities for larger workpieces. The spacing between leveling groups 2202 may also be non-uniform, with closer spacing in areas that necessitate precise control and wider spacing in areas that are likely to be level. For modular configurations that include more than one plate body 104, the leveling groups 2202 may be arranged to align with the edges of multiple plate bodies 104 when assembled, such as to ensure seamless leveling across joined surfaces. In some implementations, the plate body 104 may feature removable or repositionable leveling groups 2202, allowing users to customize the leveling system configuration based on specific project requirements or workpiece characteristics.

Accordingly, a configuration of the leveling components 2002 and interactions with the plate body 104 through the leveling groups 2202 may enable precise control over the orientation and position of the plate body 104 relative to the frame assembly 106. This adjustability may be beneficial for achieving a level surface for welding or other precision work, such as to remedy imperfections or irregularities caused by the plate body 104, the frame assembly 106, and/or the base assembly 108.

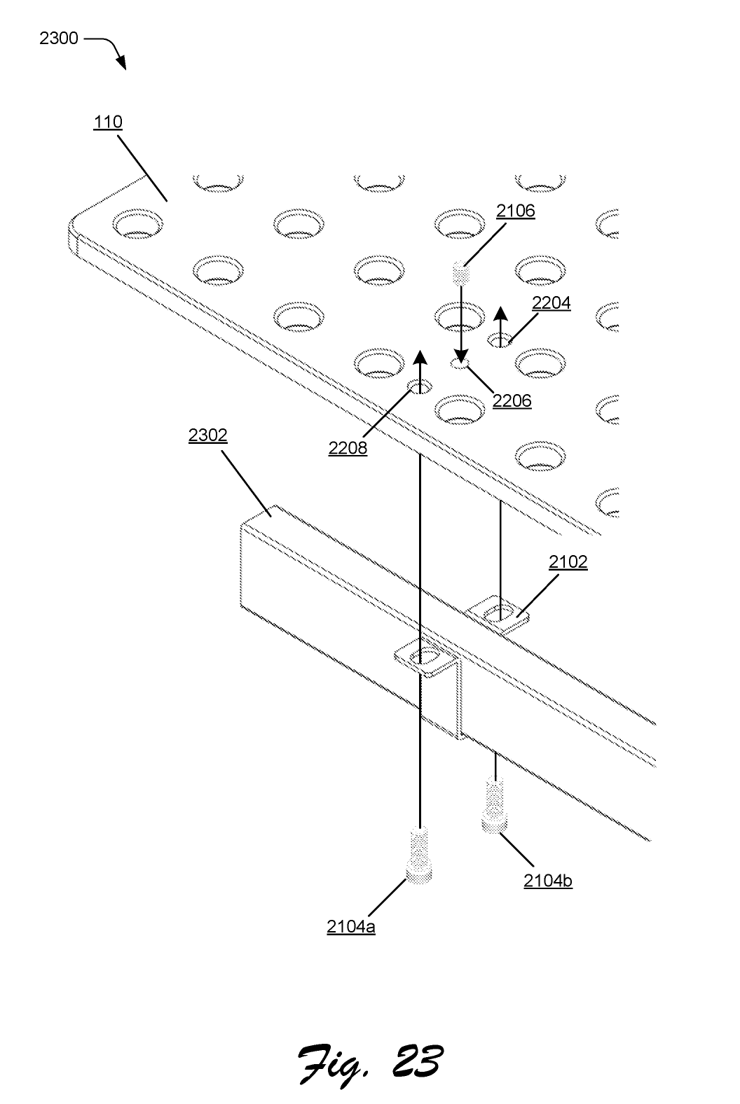

FIG. 23 depicts an example 2300 of components of a leveling system to attach a plate body 104 to a frame assembly 106 in accordance with one or more implementations. The example 2300 depicts a mounting bracket 2102, fasteners 2104 (e.g., a first fastener 2104a and a second fastener 2104b), and a leveling screw 2106. The plate body 104 includes a set of apertures, such as a first leveling aperture 2204, a second leveling aperture 2206, and a third leveling aperture 2208. A frame member 2302 of the frame assembly 106 may be positioned within an interior portion of the mounting bracket 2102.

In this example, the plate body 104 can be secured to the frame member 2302 via the leveling component 2002. For instance, the first fastener 2104a and second fastener 2104b may be inserted through apertures in the mounting bracket 2102 and into the first leveling aperture 2204 and third leveling aperture 2208 of the plate body 104, respectively. The leveling screw 2106 may also be inserted into the second leveling aperture 2206, allowing for adjustable contact with the frame member 2302 to fine-tune the positioning of the plate body 104.

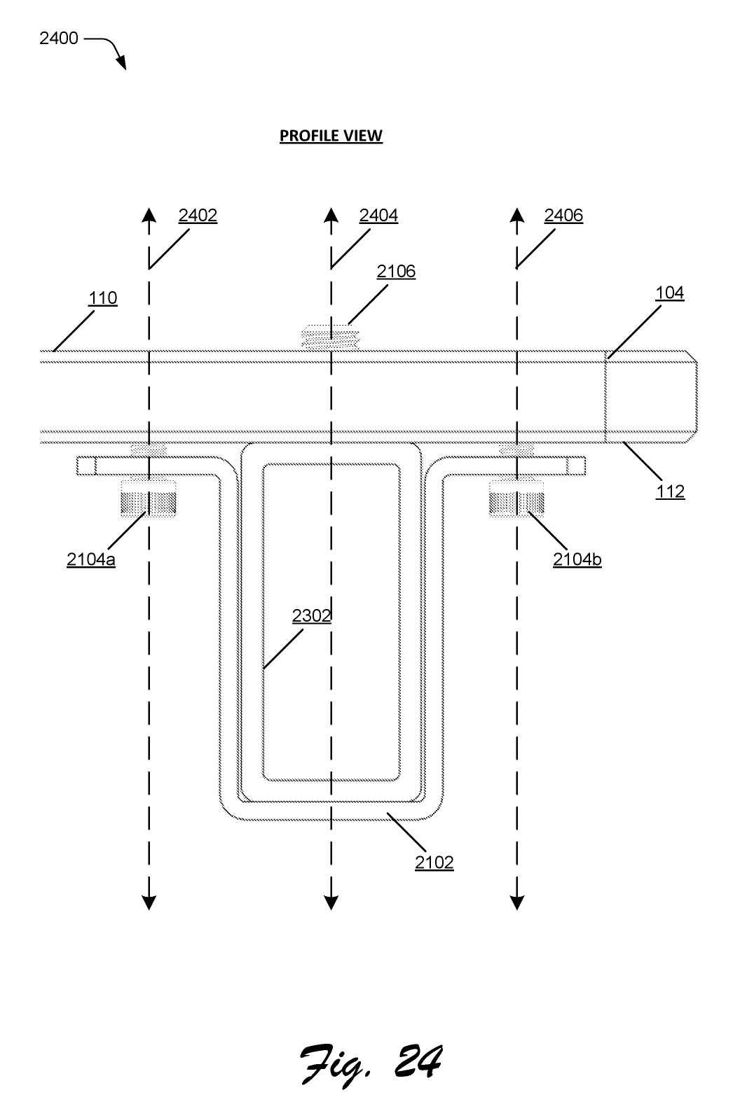

FIG. 24 depicts an example 2400 of a portion of the plate body 104 attached to the frame assembly 106 via a leveling component 2002 in accordance with one or more implementations. As illustrated, the first fastener 2104a and the second fastener 2104b extend through the mounting bracket 2102 and into the plate body 104. The leveling screw 2106 extends through the plate body 104 and contacts the frame member 2302. While shown in this figure as protruding above the top surface 110, in some examples the leveling screw 2106 is positioned within the second leveling aperture 2206 such that the leveling screw 2106 does not protrude above the top surface 110.

In some cases, adjustment of the first fastener 2104a may cause a force to be applied to the plate body 104 along a first vertical axis 2402. This force may be in a first direction substantially perpendicular to the top surface 110 of the plate body 104, such as a “pulling” force to secure the frame member 2302 to the bottom surface 112 of the plate body 104. In some examples, rotation of the first fastener 2104a in a first direction (e.g., a clockwise turn) causes a force in the first direction while rotation of the first fastener 2104a in a second direction (e.g., a counterclockwise turn) causes a force in a second direction opposite the first direction.

Additionally, adjustment of the leveling screw 2106 may cause a force to be applied to the plate body 104 along a second vertical axis 2404. This force may be in a second direction substantially perpendicular to the top surface 110 of the plate body 104, such as a “pushing” force to adjust the position of the plate body 104 relative to the frame member 2302. In some examples, a direction of rotation of the leveling screw 2106 determines a directionality of the force while a degree of rotation determines a magnitude of the force.

Similarly, adjustment of the second fastener 2104b may cause a force to be applied to the plate body 104 along a third vertical axis 2406. This force may also be in the first direction substantially perpendicular to the top surface 110 of the plate body 104, such as a “pulling” force to secure the frame member 2302 to the bottom surface 112 of the plate body 104. Further, a direction of rotation of the second fastener 2104b (e.g., clockwise, or counterclockwise) determines a direction of force applied.

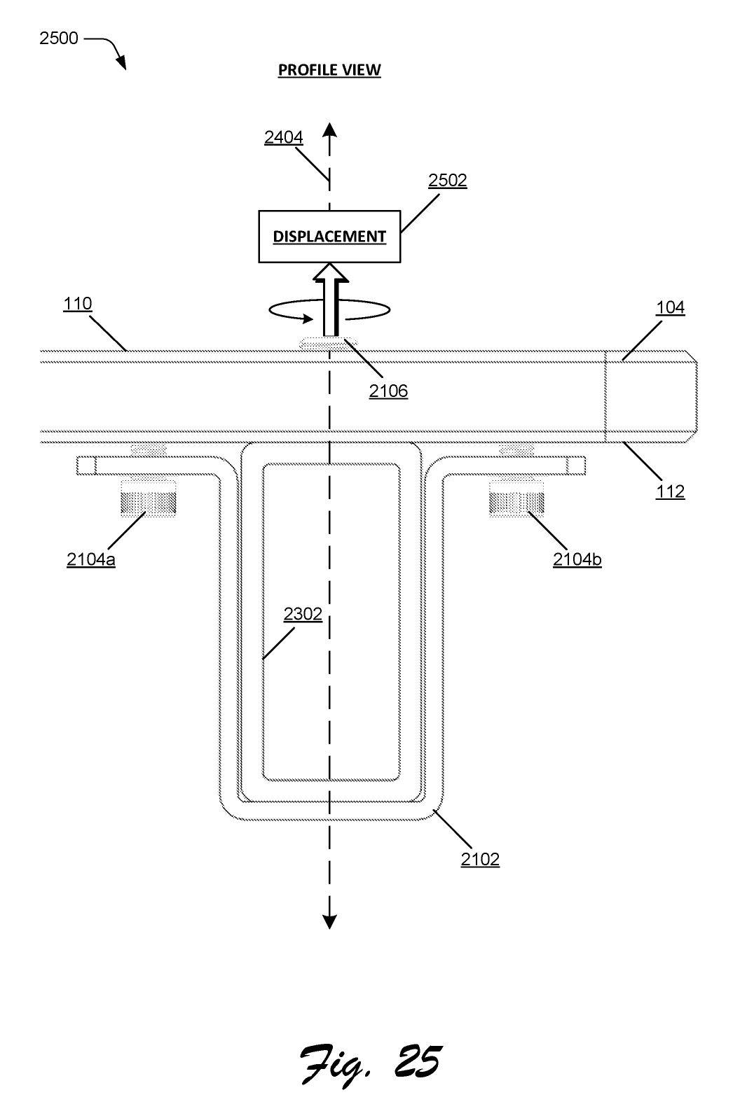

FIG. 25 depicts an example 2500 showing adjustment of the leveling screw 2106 in accordance with one or more implementations. In this example, rotation of the leveling screw 2106 causes threads of the leveling screw 2106 to engage with threads of the second leveling aperture 2206 and thus causes a force to be applied along the second vertical axis 2404. For instance, clockwise rotation of the leveling screw 2106 may push against the top of the frame member 2302, such as to raise the plate body 104 relative to the frame member 2302. This may result in a displacement 2502 of the plate body 104 in an upward direction. Counterclockwise rotation of the leveling screw 2106, for instance, may have an opposite effect such as an opposite displacement.

FIG. 26a depicts an example 2600a showing adjustment of the first fastener 2104a and the second fastener 2104b in accordance with one or more implementations. In this example 2600a, these adjustments may cause forces to be applied along the first vertical axis 2402 and the third vertical axis 2406. For example, clockwise rotation of the first fastener 2104a and the second fastener 2104b may “pull” the plate body 104 downward such as to cause a displacement 2602 and a displacement 2604 in a downward direction. Counterclockwise rotation of the fasteners 2104, for instance, may have a substantially opposite effect such as an opposite direction of displacement.

The leveling system may further allow for differential tightening of the fasteners 2104 and/or leveling screws 2106. This differential tightening may enable creation of intentional angles or compensation for irregularities in the frame assembly 106. For instance, tightening the first fastener 2104a relatively more than the second fastener 2104b may result in a slight tilt of the plate body 104. Accordingly, implementation of the leveling components 2002 provides a range of adjustment capabilities, allowing users to fine-tune the plate body 104 position and/or orientation to accommodate various use cases, such as to create precise angles for specialized welding tasks, compensate for uneven surfaces, or ensure a level work area for precision fabrication projects.

In at least one example, the threads of the first leveling aperture 2204 may have a different pitch or thread count compared to the threads of the third leveling aperture 2208. This configuration may allow for precise and controlled creation of specific angles in the plate body 104 through equivalent rotations of the first fastener 2104a and the second fastener 2104b. For instance, the first leveling aperture 2204 may have a relatively finer thread pitch (e.g., 20 threads per inch) while the third leveling aperture 2208 may have a relatively coarser thread pitch (e.g., 16 threads per inch). In this scenario, an equal number of rotations applied to both the first fastener 2104a and the second fastener 2104b may result in different vertical displacements along their respective axes. For instance, the first fastener 2104a (which is configured to engage with the relatively finer thread pitch of the first leveling aperture 2204) would travel a shorter distance vertically relative to the second fastener 2104b (which is configured to engage with the relatively coarser thread pitch of the third leveling aperture 2208) with a same number of rotations.

This difference in vertical displacement may create a predictable angular tilt in the plate body 104. For example, if both fasteners 2104 are rotated clockwise by a same amount (e.g., 5 full rotations), the side of the plate body 104 adjacent to the coarser-threaded aperture (e.g., the third leveling aperture 2208) is pulled down further than the side near the finer-threaded aperture, e.g., the first leveling aperture 2204. Accordingly, a desired angle of tilt of a portion of the plate body 104 can be defined by a ratio of a thread pitch difference and a number of rotations applied. Thus, the second aperture configuration 204 is configurable with apertures of variable thread counts to support predictable angular adjustment.

FIG. 26b depicts an example 2600b in which one or more components of the leveling system are configured to provide an angular force in accordance with one or more implementations. In some examples, one or more of the first fastener 2104a, the second fastener 2104b, and/or the leveling screw 2106 are insertable at an angle, e.g., at non-perpendicular angles. By way of example, as illustrated in FIG. 26b the first fastener 2104a is inserted at a non-perpendicular angle relative to the top surface 110 of the plate body 104. This angled configuration may allow for application of forces along both vertical and horizontal axes simultaneously.

For instance, the mounting bracket 2102 includes an angled aperture 2606, which is dimensioned to coincide with an angled aperture 2608 of the plate body 104. Thus, once inserted into the angled aperture 2606 and the angled aperture 2608, the first fastener 2104a is configured to apply a force along a non-perpendicular axis 2610. Thus, adjustment of the first fastener 2104a in a particular direction, e.g., clockwise rotation, causes an angular displacement 2612 of the plate body 104 relative to the frame assembly 106.

In various examples, one or more of the first leveling aperture 2204, second leveling aperture 2206, and/or third leveling aperture 2208 (and/or corresponding apertures of the mounting bracket 2102) are configured with angled apertures. In some embodiments, one or more of the first leveling aperture 2204, second leveling aperture 2206, and/or third leveling aperture 2208 may incorporate threaded inserts with pivoting or ball-joint mechanisms. These mechanisms may allow the fasteners 2104 and/or leveling screw 2106 to be inserted at various controllable angles relative to the plate body 104. Additionally, these adjustable mounting components may include locking features to secure the respective aperture at a desired angle, such as to ensure stability during use.

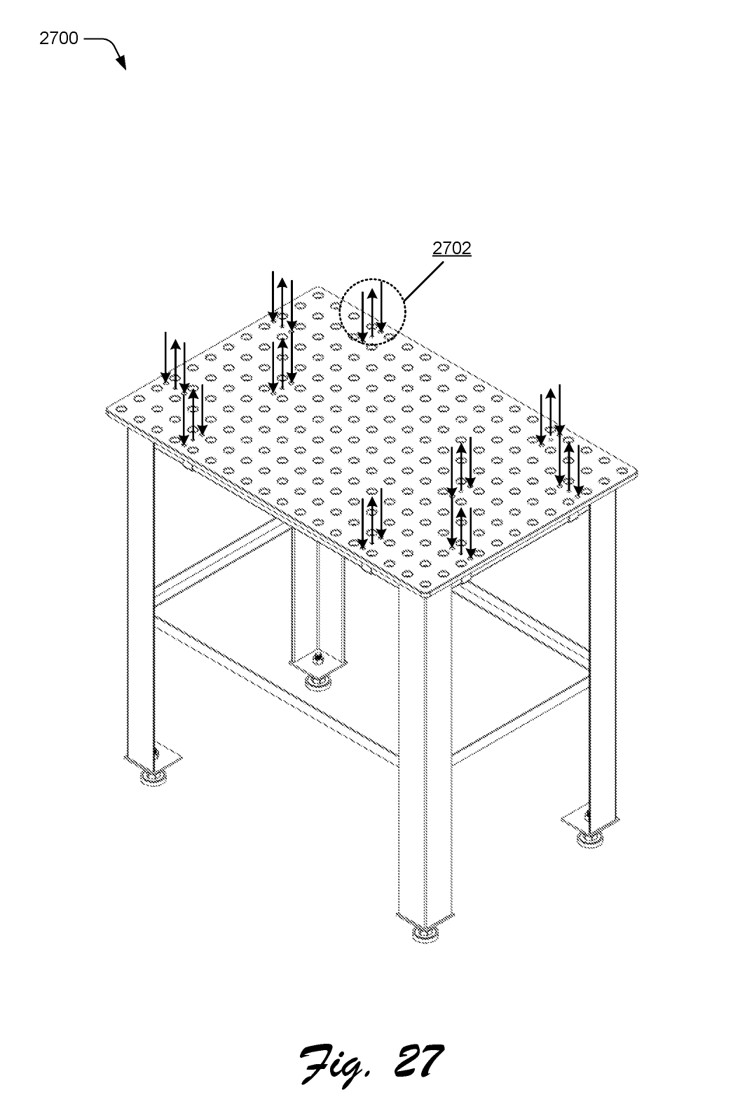

FIG. 27 depicts an example 2700 showing a leveling system that includes multiple leveling components in accordance with one or more implementations. The example 2700 depicts potential forces and areas of adjustment for the plate body 104. A displacement indicator 2702, for instance, represents potential displacements that may be caused by an individual leveling component 2002. While depicted with arrows positioned in a particular direction, it should be understood that the components of each leveling component 2002 (e.g., the fasteners 2104 and/or the leveling screw 2106) may provide force and/or displacement in either direction along a vertical axis perpendicular to the top surface of the plate body 104 in accordance with the techniques and components previously described.

The example 2700 illustrates a configuration where multiple leveling components 2002 are strategically positioned around the perimeter and central regions of the plate body 104. The displacement indicators 2702 are shown at various points, including the corners, along the edges, and in a central area of the plate body 104. This arrangement may provide comprehensive coverage for leveling adjustments across the surface of the plate body 104. For instance, leveling components 2002 positioned at the corners and edges may offer enhanced stability and control over an orientation of the modular plate assembly 102, while centrally positioned leveling components 2002 may allow for additional support and adjustment capabilities.

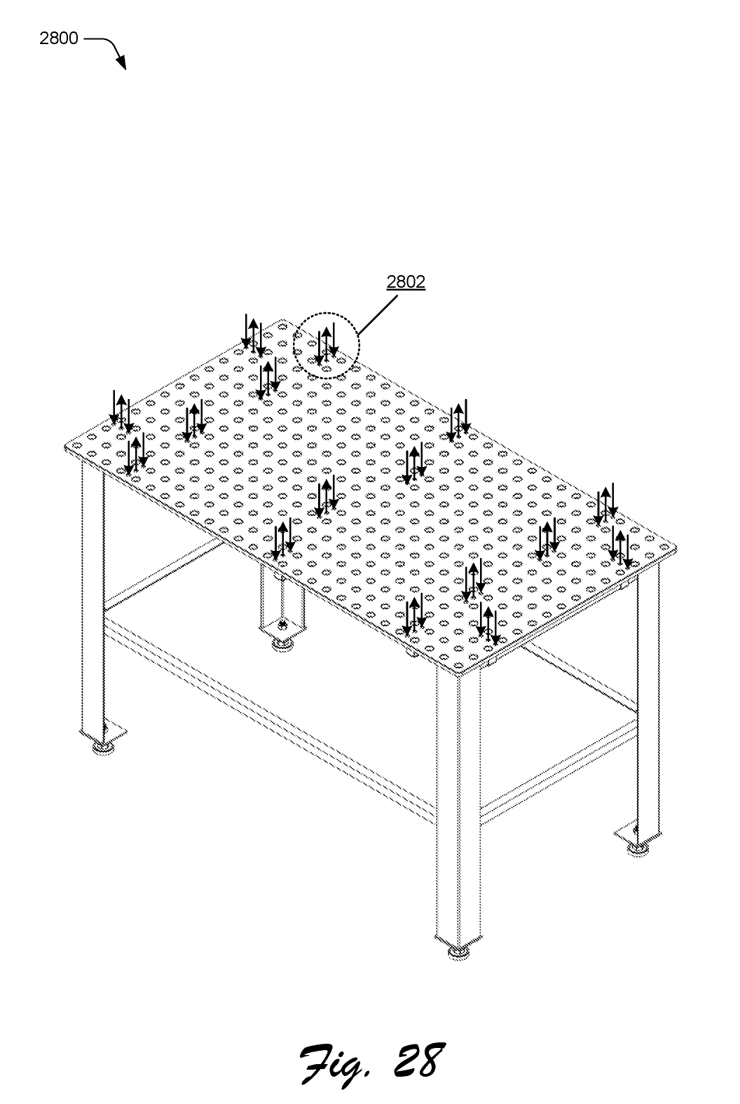

FIG. 28 depicts an example 2800 showing a leveling system that includes multiple leveling components in accordance with one or more implementations. The example 2800 illustrates a relatively larger plate body 104 and further includes a leveling system configuration with a higher number of leveling components 2002 relative to the example 2700. For instance, the example 2800 depicts sixteen different leveling components 2002, as shown by a position of the displacement indicators such as the circled displacement indicator 2802.

In this example, the leveling components 2002 are arranged in five “rows”, with two rows of two leveling components 2002 at either end and three rows of four leveling components 2002 that are distributed across the plate body 104. Further, a center row includes leveling components 2002 in a staggered pattern. The staggered pattern, for instance, provides enhanced stability by distributing forces evenly across a central member of the frame assembly 106 such as to prevent “bowing” of the plate body 104. In at least one example, the leveling groups 2202 are spaced such that a “range” of a first leveling group 2202 abuts a range of an adjacent leveling group 2202. Additionally or alternatively, the leveling groups 2202 are distributed such that a range of a first leveling group 2202 overlaps a range of one or more adjacent leveling group 2202 by a defined percentage, e.g., 5% overlap, 10% overlap, 25% overlap, 50% overlap, and so forth.

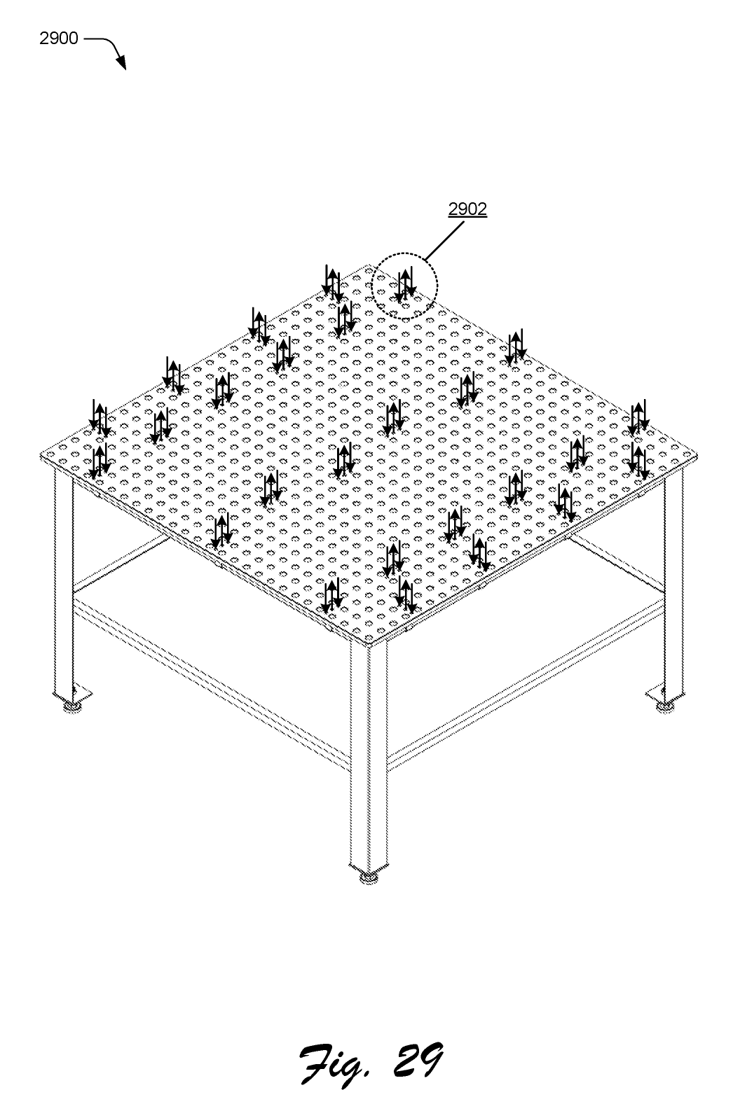

FIG. 29 depicts an additional example 2900 showing a leveling system that includes multiple leveling components 2002 in accordance with one or more implementations. The example 2900 illustrates a large plate body 104 and includes a leveling system configuration with a higher number of leveling components relative to the examples 2700 and 2800. For instance, the example 2900 depicts twenty-six different leveling components, as shown by the positions of the displacement indicators, e.g., the displacement indicator 2902, distributed across the plate body 104.

As illustrated, the leveling components 2002 in the example 2900 are strategically arranged in a strategic pattern to provide comprehensive adjustment capabilities across the relatively large plate body 104. The configuration of leveling components 2002 includes multiple rows of leveling components 2002 along the perimeter of the plate body 104, with additional components positioned in the interior regions. This arrangement may allow for precise control over an orientation and flatness of the plate body 104. Further, a staggered positioning of leveling components 2002, such as in a central area of the plate body 104, may enhance stability and evenly distribute forces across the frame assembly 106. This configuration may allow users to address localized irregularities or create intentional slopes or angles in specific areas of the plate body 104 as needed for various fabrication tasks.

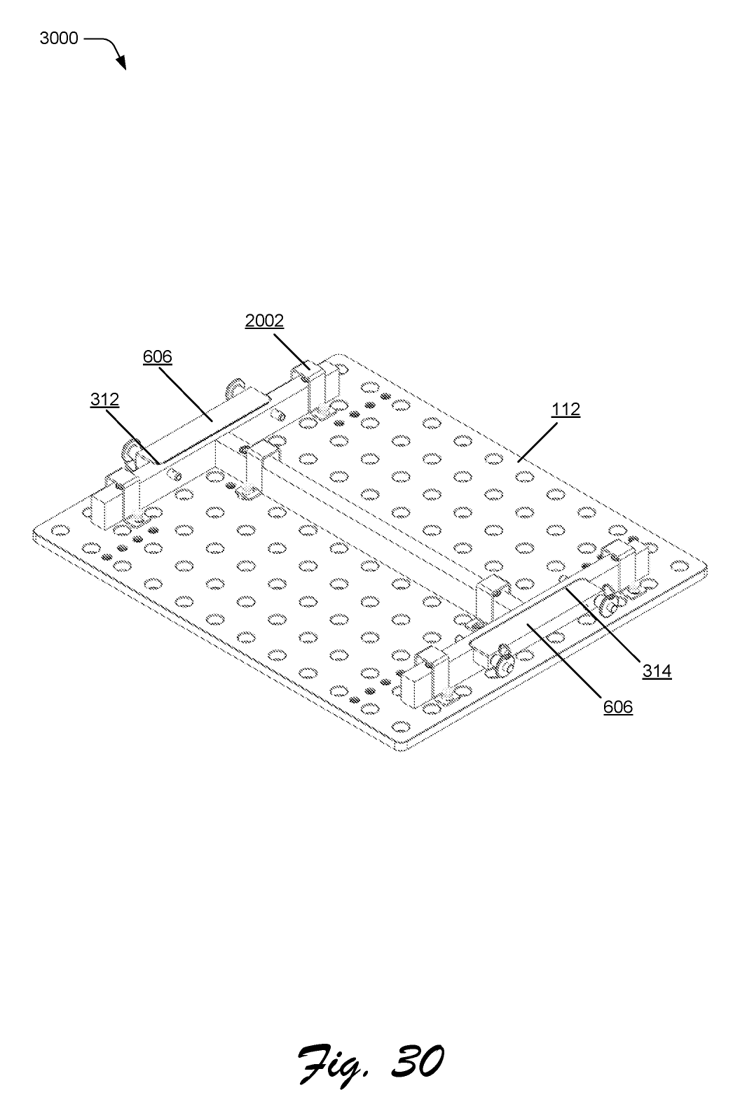

FIG. 30 depicts an example 3000 in which a modular plate assembly 102 includes a leveling system and an alignment system in accordance with one or more implementations. As illustrated, the plate body 104 is attached to a frame assembly 106 by various leveling components 2002. Further, the frame assembly 106 includes a first alignment groove 312 and a second alignment groove 314, which in this example are depicted as attached to a first alignment protrusion 606 and a second alignment protrusion 608, respectively.

Accordingly, the example 3000 illustrates how the modular plate assembly 102 can integrate both the leveling system and the alignment system to provide enhanced functionality and precision that would not be possible with either system alone. The alignment system ensures consistent and repeatable positioning of the plate body 104 relative to the base assembly 108, while the leveling system enables fine-tuned adjustments to achieve a level surface and/or to create intentional angles. When used together, these systems create a synergistic effect where the alignment system provides a macro-positioning framework, such as to establish a consistent starting point, while the leveling system offers micro-adjustments to support fine-tuned work surface configurations.

By way of example, a user can quickly attach the plate body 104 to the base assembly 108 using the quick-release components of the alignment system, such as to achieve a desired position through the alignment grooves 312, 314 and alignment protrusions 606, 608. Once secured in the desired position, the user can then employ the leveling components 2002 to make precise adjustments to compensate for irregularities in the frame assembly 106 and/or to create particular angles to support various welding tasks. This dual-system approach eliminates allows users to rapidly reconfigure a workspace while maintaining precise standards for surface flatness and orientation. The combined systems further provide enhanced stability during heavy-duty operations, as the alignment system secures the overall position while the leveling system distributes forces evenly across the work surface.

Generally, the various structures and features discussed herein modular plate body assemblies and components are combinable in various ways including implementations not expressly illustrated herein to provide for a variety of different modular plate body assemblies and components.

### Conclusion

Accordingly, modular plate assemblies and techniques associated with modular plate assemblies are described. The modular plate assemblies are usable to enable precise alignment, secure attachment, and customizable leveling of work surfaces through the modular design, alignment systems and components, and leveling systems and components to provide capabilities not achievable with conventional tables and techniques. Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention. Additional aspects of the techniques, features, and/or methods discussed herein relate to one or more of the following:

In some aspects, the techniques described herein relate to a modular plate assembly including: a plate body that includes a top surface, a bottom surface, and apertures that extend through the plate body from the top surface to the bottom surface; a frame assembly attachable to the bottom surface of the plate body via one or more of the apertures, the frame assembly including one or more alignment members that each have an alignment groove; and a base assembly configured to support the plate body and the frame assembly, the base assembly including one or more alignment protrusions dimensioned to coincide with the alignment grooves to attach the base assembly to the frame assembly at a particular orientation and position.

In some aspects, the techniques described herein relate to a modular plate assembly, wherein the plate body includes a first configuration of apertures having a first diameter arranged in a grid pattern and a second configuration of apertures of a second diameter configured to attach the frame assembly to the plate body.

In some aspects, the techniques described herein relate to a modular plate assembly, further including one or more adjustable feet attached to the plate body via the second configuration of apertures.

In some aspects, the techniques described herein relate to a modular plate assembly, wherein in the one or more alignment protrusions include perpendicular apertures dimensioned to coincide with corresponding perpendicular apertures of the alignment grooves.

In some aspects, the techniques described herein relate to a modular plate assembly, further including one or more quick-release pins insertable into the perpendicular apertures of the one or more alignment protrusions and the perpendicular apertures of the alignment grooves to attach the frame assembly to the base assembly.

In some aspects, the techniques described herein relate to a modular plate assembly, wherein the one or more quick-release pins are configured to disengage from the perpendicular apertures of the one or more alignment protrusions and the perpendicular apertures of the alignment grooves to detach the frame assembly from the base assembly.

In some aspects, the techniques described herein relate to a modular plate assembly, wherein the base assembly includes a locking rotational component to position the plate body at one or more rotational orientations.

In some aspects, the techniques described herein relate to a modular plate assembly, wherein the plate body is attached to the frame assembly by a leveling system that includes one or more leveling components, each leveling component including: a bracket dimensioned to partially surround a member of the frame assembly; one or more attachment pins to provide a force in a first direction along a vertical axis perpendicular to the top surface of the plate body to secure the member to the bottom surface of the plate body; and a leveling screw that is actuatable to apply a force in a second direction along the vertical axis to adjust a position of the plate body relative to the frame assembly, the second direction substantially opposite the first direction.

In some aspects, the techniques described herein relate to a modular plate assembly, wherein the frame assembly includes: a first alignment member having an inner surface and an outer surface, the outer surface having a first alignment groove; a central support member attached to a midpoint of the inner surface of the first alignment member, the central support member substantially perpendicular to the first alignment member; and a second alignment member having an inner surface and an outer surface, the outer surface having a second alignment groove, a midpoint of the inner surface of the second alignment member attached to the central support member, the second alignment member substantially parallel to the first alignment member.

In some aspects, the techniques described herein relate to a modular plate assembly that includes an alignment system, the modular plate assembly including: a plate body that includes a top surface, a bottom surface, and apertures that extend through the plate body from the top surface to the bottom surface; and a frame assembly attachable to the bottom surface of the plate body via one or more of the apertures, the frame assembly including: one or more alignment members, each alignment member having one or more perpendicular apertures and one or more alignment grooves that each include a recessed region dimensioned to coincide with a corresponding alignment protrusion of a base assembly; and a plurality of pin assemblies positionable along the one or more alignment members and dimensioned to coincide with the one or more perpendicular apertures to secure the base assembly to the frame assembly at a particular orientation.

In some aspects, the techniques described herein relate to a modular plate assembly, wherein the recessed regions have a rounded and tapered cross-sectional profile.

In some aspects, the techniques described herein relate to a modular plate assembly, wherein the apertures include a first configuration of apertures having a first diameter arranged in a grid pattern and a second configuration of apertures of a second diameter configured to attach the frame assembly to the plate body.

In some aspects, the techniques described herein relate to a modular plate assembly, further including one or more adjustable feet attached to the plate body via one or more apertures of the second configuration of apertures.

In some aspects, the techniques described herein relate to a modular plate assembly, wherein the frame assembly is attached to the plate body by one or more leveling components, the one or more leveling components configured to apply a multidirectional force to one or more members of the frame assembly along an axis perpendicular to the top surface of the plate body.

In some aspects, the techniques described herein relate to a modular plate assembly, wherein each alignment member includes two or more alignment grooves to attach the frame assembly to the base assembly at two or more orientations.

In some aspects, the techniques described herein relate to a modular plate assembly that includes a leveling system, the modular plate assembly including: a plate body that includes a top surface, a bottom surface, and apertures that extend through the plate body from the top surface to the bottom surface; and a frame assembly including one or more members to support the plate body, the frame assembly attachable to the plate body by one or more leveling components of the leveling system, each leveling component including: a bracket dimensioned to partially surround the one or more members; one or more attachment pins insertable into apertures of the bracket and one or more of the apertures of the plate body to provide a force in a first direction along a first vertical axis substantially perpendicular to the top surface of the plate body to secure the one or more members to the bottom surface of the plate body; and a leveling screw that is actuatable to apply a force in a second direction along a second vertical axis to adjust a position of the plate body relative to the frame assembly, the second direction substantially opposite the first direction.

In some aspects, the techniques described herein relate to a modular plate assembly, further including a base assembly attached to the frame assembly and configured to support the plate body and the frame assembly.

In some aspects, the techniques described herein relate to a modular plate assembly, further including an alignment system that includes one or more alignment grooves of the frame assembly and one or more alignment protrusions of the base assembly dimensioned to coincide with the one or more alignment grooves to attach the base assembly to the frame assembly at a particular orientation and position.

In some aspects, the techniques described herein relate to a modular plate assembly, wherein the apertures include a first configuration of apertures having a first diameter arranged in a grid pattern and a second configuration of apertures of a second diameter spaced at intervals adjacent to a perimeter of the top surface to enable attachment of the plate body to the frame assembly via the one or more leveling components.

In some aspects, the techniques described herein relate to a modular plate assembly, wherein the second configuration of apertures includes groups of apertures, each group of apertures corresponding to a respective leveling component and including a first aperture and a second aperture to facilitate attachment of the bracket to the bottom surface of the plate body by the one or more attachment pins and a third aperture to support engagement of the leveling screw with the plate body and the frame assembly.

What is claimed is:

1. A modular plate assembly comprising:
a plate body that includes a top surface, a bottom surface, and apertures that extend through the plate body from the top surface to the bottom surface;
a frame assembly attachable to the bottom surface of the plate body via one or more of the apertures, the frame assembly including one or more alignment members that each have an alignment groove; and
a base assembly configured to support the plate body and the frame assembly, the base assembly including one or more alignment protrusions dimensioned to coincide with the alignment grooves to attach the base assembly to the frame assembly at a particular orientation and position.

2. The modular plate assembly as described in claim 1, wherein the plate body includes a first configuration of apertures having a first diameter arranged in a grid pattern and a second configuration of apertures of a second diameter configured to attach the frame assembly to the plate body.

3. The modular plate assembly as described in claim 2, further comprising one or more adjustable feet attached to the plate body via the second configuration of apertures.

4. The modular plate assembly as described in claim 1, wherein in the one or more alignment protrusions include perpendicular apertures dimensioned to coincide with corresponding perpendicular apertures of the alignment grooves.

5. The modular plate assembly as described in claim 4, further comprising one or more quick-release pins insertable into the perpendicular apertures of the one or more alignment protrusions and the perpendicular apertures of the alignment grooves to attach the frame assembly to the base assembly.

6. The modular plate assembly as described in claim 5, wherein the one or more quick-release pins are configured to disengage from the perpendicular apertures of the one or more alignment protrusions and the perpendicular apertures of the alignment grooves to detach the frame assembly from the base assembly.

7. The modular plate assembly as described in claim 1, wherein the base assembly includes a locking rotational component to position the plate body at one or more rotational orientations.

8. The modular plate assembly as described in claim 1, wherein the plate body is attached to the frame assembly by a leveling system that includes one or more leveling components, each leveling component including: a bracket dimensioned to partially surround a member of the frame assembly; one or more attachment pins to provide a force in a first direction along a vertical axis perpendicular to the top surface of the plate body to secure the member to the bottom surface of the plate body; and a leveling screw that is actuatable to apply a force in a second direction along the vertical axis to adjust a position of the plate body relative to the frame assembly, the second direction substantially opposite the first direction.

9. The modular plate assembly as described in claim 1, wherein the frame assembly includes:
a first alignment member having an inner surface and an outer surface, the outer surface having a first alignment groove;
a central support member attached to a midpoint of the inner surface of the first alignment member, the central support member substantially perpendicular to the first alignment member; and
a second alignment member having an inner surface and an outer surface, the outer surface having a second alignment groove, a midpoint of the inner surface of the second alignment member attached to the central support member, the second alignment member substantially parallel to the first alignment member.

10. A modular plate assembly that includes an alignment system, the modular plate assembly comprising:
a plate body that includes a top surface, a bottom surface, and apertures that extend through the plate body from the top surface to the bottom surface; and
a frame assembly attachable to the bottom surface of the plate body via one or more of the apertures, the frame assembly including:
one or more alignment members, each alignment member having one or more perpendicular apertures and one or more alignment grooves that each include a recessed region dimensioned to coincide with a corresponding alignment protrusion of a base assembly; and
a plurality of pin assemblies positionable along the one or more alignment members and dimensioned to coincide with the one or more perpendicular apertures to secure the base assembly to the frame assembly at a particular orientation.

11. The modular plate assembly as described in claim 10, wherein the recessed regions have a rounded and tapered cross-sectional profile.

12. The modular plate assembly as described in claim 10, wherein the apertures include a first configuration of apertures having a first diameter arranged in a grid pattern and a second configuration of apertures of a second diameter configured to attach the frame assembly to the plate body.

13. The modular plate assembly as described in claim 12, further comprising one or more adjustable feet attached to the plate body via one or more apertures of the second configuration of apertures.

14. The modular plate assembly as described in claim 10, wherein the frame assembly is attached to the plate body by one or more leveling components, the one or more leveling components configured to apply a multidirectional force to one or more members of the frame assembly along an axis perpendicular to the top surface of the plate body.

15. The modular plate assembly as described in claim 10, wherein each alignment member includes two or more alignment grooves to attach the frame assembly to the base assembly at two or more orientations.

16. A modular plate assembly that includes a leveling system, the modular plate assembly comprising:
a plate body that includes a top surface, a bottom surface, and apertures that extend through the plate body from the top surface to the bottom surface; and
a frame assembly including one or more members to support the plate body, the frame assembly attachable to the plate body by one or more leveling components of the leveling system, each leveling component including:
a bracket dimensioned to partially surround the one or more members;
one or more attachment pins insertable into apertures of the bracket and one or more of the apertures of the plate body to provide a force in a first direction along a first vertical axis substantially perpendicular to the top surface of the plate body to secure the one or more members to the bottom surface of the plate body; and
a leveling screw that is actuatable to apply a force in a second direction along a second vertical axis to adjust a position of the plate body relative to the frame assembly, the second direction substantially opposite the first direction.

17. The modular plate assembly as described in claim 16, further comprising a base assembly attached to the frame assembly and configured to support the plate body and the frame assembly.

18. The modular plate assembly as described in claim 17, further comprising an alignment system that includes one or more alignment grooves of the frame assembly and one or more alignment protrusions of the base assembly dimensioned to coincide with the one or more alignment grooves to attach the base assembly to the frame assembly at a particular orientation and position.

19. The modular plate assembly as described in claim 16, wherein the apertures include a first configuration of apertures having a first diameter arranged in a grid pattern and a second configuration of apertures of a second diameter spaced at intervals adjacent to a perimeter of the top surface to enable attachment of the plate body to the frame assembly via the one or more leveling components.

20. The modular plate assembly as described in claim 19, wherein the second configuration of apertures includes groups of apertures, each group of apertures corresponding to a respective leveling component and including a first aperture and a second aperture to facilitate attachment of the bracket to the bottom surface of the plate body by the one or more attachment pins and a third aperture to support engagement of the leveling screw with the plate body and the frame assembly.
